(19) United States
(12) Patent Application Publication
(10) Pub. No.: US 2003/0105959 A1
(43) Pub. Date: Jun. 5, 2003

(54) System and method for providing answers in a personal entropy system

(76) Inventors: Stephen M. Matyas JR., Manassas, VA (US); Matthew A. Kamerman, Katonah, NY (US)

Correspondence Address: Whitham, Curtis & Christofferson, P.C., 11491 Sunset Hills Road, Suite 340, Reston, VA, 20190, US

(21) Appl. No.: 09/998,319

(22) Filed: Dec. 3, 2001

(51) Int. Cl. H04L 9/00

(52) U.S. Cl. 713/168; 713/202

(57) ABSTRACT

Computer user authentication and cryptographic key protection through the use of personal entropy (PE) is implemented using a PE answering algorithm which enables a user of a computing system to generate secret values from answers to questions previously created by the user. The questions are displayed to the user on a user interface (UI), and the user is prompted to select a subset of the questions to answer. When the user provides answers for the selected subset, an attempt is made to generate the secret value from a portion of the subset and possibly other information. If the secret value cannot be generated from at least a portion of the selected subset, the user is prompted to select a second subset of the displayed questions and provide answers to the selected second set of questions. When the user provides answers to the second selected subset of questions, an attempt is made to generate the secret value from a portion of the first and second sets of answers and possibly other information. The hardware implementation of PE answering algorithm has three components; the PE-controller server computer, the PE-user client controller and the PE-authentication server computer. These components are interconnected via a network. Attached to the PE-controller server is a repository of downloadable client applets which are downloaded to the PE-user client controller and used for both creating the secret value from answers supplied by the user when creating the questions in the create PE process and, later, in the recover PE process, generating the secret value from answers provided by the user to subsets of the previously created questions. The PE-authentication server computer maintains a central database where PE information created by PE users can be stored and subsequently accessed by the PE-controller server computer. The PE-authentication server computer also performs a user authentication service.

### CROSS REFERENCE TO RELATED APPLICATIONS

This application is related to U.S. patent application Ser. No. 09/883,431 filed Jun. 18, 2001 by Stephen Michael Matyas, Jr., Matthew Albert Kamerman, Pamela Jane Hensley, and Joanne Frances Rusch for “Personal Entropy Method and System” and U.S. patent application Ser. No. 09/883,441 filed Jun. 18, 2001, by Matthew Albert Kamerman, Stephen Michael Matyas, Jr., Pamela Jane Hensley, and Joanne Frances Rusch for “Personal Entropy Authentication”, both of which applications are assigned to a common assignee herewith. The disclosures of applications Ser. No. 09/883,431 and Ser. No. 09/883,441 are incorporated herein by reference.

### DESCRIPTION

### BACKGROUND OF THE INVENTION

1. Field of the Invention

The present invention generally relates to the fields of computer user authentication and cryptographic key protection and, more particularly, to computer user authentication and cryptographic key protection through the use of personal entropy.

2. Background Description

Use of personal entropy to protect secrets was first proposed by Ellison in August, 1996, in a talk given at the CRYPTO '96 rump session entitled “Emergency Key Recovery without Third Parties,” which can be found on the Internet at http://world.std.com/˜cme/ html/rump96.html. Use of personal entropy was further discussed by Carl Ellison, Chris Hall, Randy Milbert, and Bruce Schneier in an Oct. 28, 1999, paper on “Protecting Secret Keys with Personal Entropy,” subsequently published as a journal paper in Future Generation Computer Systems, v. 16, pp. 311-318 (2000), which can be found on the Internet at http://www.counterpane.com/personal-entropy.html.

Personal Entropy (hereinafter, “PE”) refers to information, drawn from a user's personal experiences, that is highly memorable to the user but is unlikely to be known to or readily guessable or derivable by anyone else. Secrets are protected by prompting the user for such information, using the information to construct a secret value (hereinafter, “PE Secret”), which Ellison mentions could be used as a cryptographic key to encrypt a passphrase, which in turn is used to encrypt and protect a secret key. However, the reader will appreciate that the PE Secret might be used for several possible purposes, e.g., as a key for encrypting and/or decrypting, or a key for computing Message Authentication Codes, or possibly a key used for digitally signing messages or data, or as a password for any number of possible existing password authentication protocols to authenticate the user, or as a secret value to seed a pseudo-random number generator. Those of ordinary skill in the art will appreciate that the present invention should not be limited to a particular use of the PE Secret.

The term “entropy” is an Information Theory term. The entropy of X where, for example, X is a key, a password, or a PE answer, is a mathematical measure of the amount of information provided by an observation of X (see Applied Cryptography, A. J. Menezes, P. C. van Oorschot, and S. A. Vanstone, CRC Press, New York, 1997, page 56). Equivalently, the entropy of X is the uncertainty about the outcome before an observation of X. Entropy is also useful for approximating the average number of bits required to encode the elements of X. If X has n possible values, and each value is equally likely, then the entropy of X, measured in bits, is given by Equation 1, as follows:

E(X)=log₂(n), Eq. 1

where log₂(n) is the logarithm to the base 2 of n. For example, a 64-bit cryptographic key would have 2⁶⁴ (i.e., 2 to the power 64) different possible values. But, if each value were equally likely, then E(X)=log₂(2⁶⁴)=64, and one would say that key X has 64 bits of entropy. In this case, the length of the key (64 bits) and the entropy in the key (64 bits) are the same, i.e., the length of the key in bits is equal to the entropy of the key in bits. However, this simple relationship does not always hold, and in fact does not hold when the elements of X are not equally likely. In this case, a more complex mathematical equation (Equation 2) is needed to calculate the entropy of X, namely:

E(X)=−[P₁×(log₂(P₁)+P₂×(log₂(P₂)+. . . +Pₙ×(log₂(Pₙ)], Eq. 2

where X₁, X₂, . . . , Xₙ are the n different values of X and P₁,P₂, . . . , Pₙ are their respective probabilities. Note that Equation 2 yields the same result as Equation 1 when all n values are equally likely. Now consider an example in which the answer to a PE question has eight possible values, viz. X₁, X₂, . . . , X₈. If each value is equally likely, then log₂(8)=log₂(2³)=3, and therefore it is said that X has three bits of entropy. On the other hand, suppose that the eight values of X are not all equally likely, but instead have probabilities, as follows: P₁=(½), P₂=(¼), P₃=(⅛), P₄=(1/16), P₅=(1/32), P₆=(1/64), P₇=(1/128), and P₈=(1/128), where the individual probabilities, of course, sum to one, i.e., P1+P2+ . . . +P₈=1. In this case, we have:

E(X)=−[(½)log₂(½)+(¼)log₂(¼)+(⅛)log₂(⅛)+

(1/16)log₂(1/16)+(1/32)log₂(1/32)+(1/64)log₂(1/64)+

(1/128)log₂(1/128)+(1/128)log₂(1/128)

=1.98,

and therefore X has about two bits of entropy instead of the theoretical maximum of three bits. This means that an attacker who knows X₁ through X₈ and can estimate the probabilities P₁ through P₈ (P₁ through P₈ are assumed not to be all equally likely), could successfully guess the user's PE answer in fewer trials than an attacker who had no knowledge about the probabilities P₁ through P₈ and therefore could make no better assumption than the default one, namely that all values are equally likely. For example, if the attacker searched the PE answers from most probable to least probable (i.e., X₁ is guessed at trial 1, X₂ is guessed at trial 2, and so forth), the chance of successfully guessing the correct PE answer in one trial, two trials, three trials, etc., would be calculated as follows:

X₁ would be correctly guessed in one trial 50% of the time.

X₁ or X₂ would be correctly guessed in two trials 75% of the time.

X₁ or X₂ or X₃ would be correctly guessed in three trials 87.5% of

the time

X₁ or X₂ or X₃ or X₄ would be correctly guessed in four trials

93.75% of the time.

One of “X₁ through X₅” would be correctly guessed in five trials 96.875% of the time.

One of “X₁ through X₆” would be correctly guessed in six trials 98.4375% of the time.

One of “X₁ through X₇” would be correctly guessed in seven trials

99.2188% of the time.

One of “X₁ through Xg” would be correctly guessed in eight trials

100% of the time.

Conversely, if the eight PE answers were equally likely, then the chance of successfully guessing the PE answer in 1 trial, 2 trials, 3 trials, etc, would be: 12.5%, 25%, 37.5%, 50%, 62.5%, 75%, 87.5%, and 100%. Note that in the second case four trials are required to reach the 50% point, whereas in the first case only one trial is required to reach the 50% point. The 50% point is of special interest, since it is a measure of the expected number of trials to find the correct PE answer. In the first case, the expected number of trials is 1; in the second case it is 4. Another way to express the 50% point would be to say, “On average, the PE answer can be found in j trials” where j=1 in the first case and j=4 in the second case. The reader will appreciate that the entropy measure itself is useful only for approximating the number trials needed to effectively search most of the information in X. In effect, the entropy measure allows one to discard the low probability elements in X and work only with high probability elements. In the example in which X has 2 bits of entropy, we see that “most of the information in X” is carried in 2^{E(X)}=4 elements of highest probability: X₁, X₂, X₃, X₄, which have a combined probability close to 1. This is easily confirmed by adding probabilities and noting that P₁+P₂+P₃+P₄=0.9375, whereas the remaining four elements: X₅, X₆, X₇, and X₈, have a combined probability of (1−0.9375)=0.0625, which by comparison is relatively small. Another property to observe about the entropy measure is that the greater the entropy associated with a cryptographic variable (e.g., key, password, PE value) the greater the protection offered by that cryptographic variable.

In their paper, Ellison et al. introduce and provide a motivation for a PE system by stating the following:

“In conventional encryption technology, users have one or more private keys (or other data) that they should keep secret. Usually the user's secret data is protected by encrypting it with a normal symmetric encryption algorithm using a key taken from the hash of a passphrase of the user's choice. However, if the user ever forgets the passphrase, then he or she loses access to the respective secret data.

Alternatively, if the passphrase is short and simple enough to be remembered with certainty, then it is probably short and simple enough for an attacker to guess.”

One solution is for the user to write the passphrase down and store it somewhere: e.g., a safe-deposit box. Another is for the system designer to eschew user-remembered passphrases entirely and store keys in physical tokens such as smart cards. Both of these solutions have problems.

In the discussion that follows, a “hint” is also called a “prompt”, where a hint or prompt may or may not be expressed in the form of a question.

As set forth in their paper, Ellison et al. have three insights with respect to PE: (1) multiple, unrelated, simple (i.e., low entropy) answers can be combined to provide the same protection as a single, complex (i.e., high entropy) answer; (2) the simple answers need not be overly difficult or impossible for an attacker to guess or derive, so long as they can be remembered far more easily than they can be guessed or derived; and (3) fault-tolerant techniques based on creating a greater number of simple answers than are required to recover the PE Secret can help avoid the inconvenience, expense, and potential catastrophe of a user forgetting a long passphrase or one or more of the PE answers. Implementation of these insights, however, has proven challenging in practice. Ellison et al.'s first insight makes the point that many simple (low entropy) answers can be combined to provide the same protection as a single, complex (high entropy) answer. But, the lower the entropy, or bits of protection per answer, the greater the number of answers required to achieve a given level of protection which, for example, may be based on an existing industry security standard. In like manner, the greater the number of answers needed, the less likely users will tolerate the system and the less attractive PE becomes. Hence, although it is true that a single high-entropy answer can be obtained by combining many low-entropy answers, as a practical matter, the usability of the system will limit the number of low-entropy answers that can be used effectively.

For practical purposes, a large number of answers are especially unworkable in frequently used PE systems, because users quickly grow impatient with work they do not perceive as necessary to their objectives. This is because routine dulls any user's sense of urgency. Therefore, users quickly grow impatient with time-consuming data-entry scenarios (e.g., authentication systems requiring large amounts of data to be input), no matter how sensitive the data or activities are that PE may protect. So, the more frequently PE is used, the less protection—in the form of questions to be answered—users tolerate. But, the fewer the answers tolerated, the lower the entropy of the PE Secret. Hence, the challenge is to deliver on Ellison et al.'s first insight.

According to Ellison's et al.'s second insight, a PE solution is very sensitive to how well users choose answers that are easy for them to remember but fairly hard for anyone else to guess or derive. Ellison et al. describe three different methods for choosing questions, although they concede that this is an area ripe for future human-interface research.

First Method

In the first method, the system stores a list of questions that should apply to nearly everyone. During enrollment, which is the process of setting up the user on the system, the user is prompted with a series of predefined system-generated questions. For each such question, if the user answers the question, then the question and answer (Q&A) is lifted and made part of that user's list of Q&As. If the user chooses not to answer the question, then that question is ignored and the process continues until the user has answered enough questions to provide both the desired degree of protection and sufficient extra Q&A to allow for user's memory blocks while trying to recall some of the answers.

The first method (list of standard questions) has the advantage that users are relieved of the responsibility for creating questions themselves. The disadvantage is that the user must select from among the questions displayed, and therefore the user has less latitude or freedom to construct answers that will be hard for the attacker to guess. Overall, this gives rise to answers with less entropy.

Although the “list of standard questions” approach removes most of the thinking burden from the user, it has three major failings. First, commonplace questions evoke commonplace answers, and commonplace answers are easier to guess (for example, from word association lists garnered from online discussions of such topics and sorted by frequency) than the topic of a uniquely personal experience. Second, questions that apply to everyone are not particularly memorable by anyone, so the likelihood of a memory block is increased versus a Q&A drawn from a particularly vivid, uniquely personal experience. Third, the topics of many commonplace questions such as “who was your first grade teacher?” are not readily available online right now, but matters of public record might at anytime become available in the future. The effect of the first and second problems are to drive up the number of Q&A required—first to achieve some given level of protection, and second to provide enough extra questions to ensure against forgotten answers. The third problem offers a potentially catastrophic risk of making one or more Q&A no longer even qualify as PE once the topic becomes available to online attackers (for example, if a Board of Education's records go online), along with the likelihood that neither the user nor the PE system's administrators would know that the topic has become invalid as a source for PE questions.

Second Method

In the second method, it is possible for users to generate prompts tailored to themselves, although Ellison et al. state that “this procedure adds difficulty” and “we have discovered that it takes considerable time to get into the right frame of mind to generate prompts.” Ellison et al. continue by saying: “The prompts have ‘answers’ that make sense only to the person who created them, and can be much harder for an attacker to figure out then the answers to questions intended for everyone. The trick is to select just enough of a reminder to trigger a strong memory in the user (preferably from childhood, so that one knows the memory is long-term and fully established), but not enough of a reminder to give a private investigator anything to go on. The more misleading the prompt, the better.” Finally, Ellison et al. conclude by saying: “The problem with this approach is that we have not yet discovered if every possible user is capable of getting into this frame of mind. Neither have we discovered a procedure for inducing that frame of mind.” Resolving the difficulties, Ellison et al. discovered, and thereby reaping the benefits of the much harder to guess PE answers from this second proposed method, is one of the principal objectives of this current invention.

Third Method

In the third method (called free association prompts), the system generates prompts as random collections of English words and the user selects those that mean something to the user and skips those that do not. These prompts have the advantage of being related to mental state rather than physical events. Hence, they have the potential of being stronger against private investigators. On the other hand, they have the disadvantage that they might not be answered with reasonably high probability, since the mental state and physical environment in which the free association to the prompt was first elicited may have to be present or well recalled, before the free association itself can be recalled.

Summary

In summary, Ellison et al. favor the first method, as they developed an implementation based on this concept. The third method was not studied enough to arrive at a conclusion about its viability. But, Ellison et al. did study the second method, which they say has the possibility for producing answers of higher entropy than the first method, although it seems that the authors were frustrated by an inability to find a way to instruct or guide users how to create good PE questions and answers, or to develop (in their words) “a procedure for inducing that frame of mind.” Moreover, Ellison et al. do not describe a solution for how a novice might be directed to create suitable hints (questions or prompts) and corresponding answers.

Based on the foregoing discussion, it is understood and appreciated that in a good PE system it is necessary to strike an appropriate balance between security and usability while at the same time attempting to maximize each of these parameters independently. A good PE system should provide appropriate security, but it should also be a workable and usable system. A workable and usable PE system cannot achieve an appropriate level of security with only low-entropy answers by merely providing more answers, since there is a practical limit on how many answers a user will tolerate. What is needed is a method that will provide answers with greater entropy so that an equivalent level of protection can be achieved with fewer answers, thereby making the system more tolerable to its users. Therefore, it is desirable to provide a PE system that optimally balances security and usability such that the number of required answers is few enough to be easily created, remembered, and keyed into the system, yet sufficient in quantity and quality to provide enough entropy to meet the business requirements of the intended application.

It is apparent that Ellison et al's first method is not a viable candidate method to achieve an optimal balance of security and usability, since answers are “forced” and, therefore, the average entropy per answer is likely to be low with no apparent means to increase the entropy of answers. The third method is also not a viable candidate method, since it is an untested concept that does not even predict answers with higher entropy than the first method. Conversely, the second method does predict answers with higher entropy than the first method and therefore is capable of meeting the PE system objective of balancing security and usability. Although easily explained, Ellison et al.'s third insight concerning fault-tolerant techniques has proved challenging to implement. For example, Ellison et al. proposed the use of Shamir's Secret Sharing scheme based on Lagrange Interpolation over a finite field modulo a prime (see A. Shamir, “How to Share a Secret,” Communications of the ACM, 22, No. 11, pp. 612-613, November 1979) in their PE system. In an m of n secret sharing scheme, there are n secret shares and any m of the secret shares will allow the secret to be recovered.

However, the secret sharing scheme relied on by Ellison et al. has been shown to reduce to an often much more easily solved problem—the noisy polynomial interpolation problem (see D. Bleichenbacher and P. Q. Nguyen, “Noisy Polynomial Interpolation and Noisy Chinese Remaindering,” Advances in Cryptology—Proceedings of EUROCRYPT 2000, Lecture Notes in Computer Science, Vol. 1807, Springer-Verlag, 2000, pp. 53-69). Bleichenbacher and Nguyen have shown that the noisy polynomial interpolation problem (under most conditions) offers only slightly more than half the number of bits of protection than previously expected. Therefore, systems relying on the noisy polynomial interpolation problem must double the number of challenges (questions and answers) to obtain the same degree of protection that they previously were thought to provide.

The noisy polynomial interpolation problem is one of a class of intractability assumptions upon which the security of a cryptographic method can be based. Intractability proofs are very difficult, and often the best that can be done is to demonstrate an analogy to another mathematical problem that has also been shown (or at least is widely believed) to have a certain degree of difficulty, in this case the noisy polynomial interpolation problem. However, the weakness in the noisy polynomial interpolation problem discovered by Bleichenbacher and Nguyen demonstrates the risk of basing a cryptographic system on mathematical methods which have not been adequately reviewed and evaluated over a significant period, perhaps years, by some significant portion of the cryptanalytic community. Therefore, it is desirable to provide a PE system solution that incorporates fault-tolerance, but that does not require the use of a secret sharing scheme based on the noisy polynomial interpolation problem.

Bleichenbacher and Nguyen recommend that cryptographic protocols should, if possible, be based on the polynomial reconstruction problem (another intractability problem) rather than the noisy polynomial interpolation problem. Delivering on Bleichenbacher and Nguyen's recommendation is not one of the objects of the current invention, but those versed in the art will appreciate that those attempting to do so will run the same risk of having it be discovered that their implementation for most practical purposes reduces to a more easily solved problem. The above discussion illustrates the risk to a security system of being an early adopter of a cryptographic technique depending on new, or otherwise little analyzed or tested implementation of an intractability assumption. Providing a method for delivering on Ellison et al.'s third insight without using unproven cryptographic techniques is one of the principal teachings of the current invention.

In Ellison et al.'s PE system, the user must answer n questions. In other words, Ellison et al. employ an “answering algorithm” wherein the user answers all n questions. The system then attempts to find a subset consisting of m answers that will recover the correct PE Secret. Since there are (n!)/[(n-m!)!(m!)] possible (canonically ordered) subsets of m answers, the system may be required to test more than one subset in order to find a subset that allows the correct PE Secret to be recovered. In other words, the “answering algorithm” may have to test several subsets of m answers to find one that will recover the PE secret. Of course, if all n answers are correct, then only one trial is required. However, if there are some incorrect answers, provided there are not more than n−m incorrect answers, then two or more trials are required to recover the correct PE value. Moreover, depending on the order in which the system encounters the erroneous answer(s), effort—combinatorial on the number of errors—may be required to either find a valid subset or prove no valid subset exists. Combinatorially varying performance can severely damage users' confidence in a system by causing unacceptable wait times for not only an erring user, but others waiting for a response from an over-loaded security system.

It is noteworthy that if the user enters all n answers correctly, then the user will have provided n−m extra answers that are not needed in order to recover the correct PE Secret. In short, Ellison et al.'s PE system requires the user to always provide n answers when only m<n answers may be sufficient. In one implementation of their method, Ellison et al. suggest to use values of n=22 and m=14 (i.e., the “answering algorithm” is based on n=22 and m=14), which of course means that the user provides eight additional answers when fourteen answers are all that (assuming no errors) are needed. The extra answers place an additional burden on the PE system to handle and process this additional information. However, the primary disadvantage of this approach is that it places an extra burden on the user. The user must enter answers that may not, and almost certainly will not, be needed in all cases to recover the correct PE Secret.

Therefore, it is desirable to provide a PE system (i.e., the “answering algorithm”) that requires users to enter a minimal number of answers in order to recover the correct PE Secret. Furthermore, it would be desirable for a PE system or “answering algorithm” to be provided that requires users to enter only m answers, and which only requires additional user effort if the correct PE Secret fails to be recovered (e.g., answers to additional questions or answers to the same questions on the assumption that a keying error has occurred). Providing a means to realize the benefits of “extra” PE Q&A without requiring extra user or system effort except when the first m answers attempted contain an error is one of the objects of the current invention.

Several existing applications utilize secret personal information to authenticate users. For example, Equifax Secure markets a product called eIDverifier™, which is described as “a highly accurate, economical,” online, one-on-one tool that “allows you to authenticate the identity of individuals accessing your web-site” (see http://www.equifaxsecure.com/ identityverification/iv₁₃ products.html.). The authentication program produces an assessment score and reason codes by making a comparison of consumer-provided information with Equifax and other industry data sources. Acceptable risk cutoff levels are determined by customers themselves to fit their industry and business requirements. The verification process has three steps, as follows: First, “The user completes and submits 20 an online application form. eIDverifier performs edits and validations on the data elements supplied by the consumer and then verifies key data fields including Social Security number, address, driver's license, phone number and age. Additionally, the consumer-supplied data is compared to the content of multiple databases.” Second, “[t]he Equifax Secure authentication engine displays a multiple-choice questionnaire compiled from information managed by consumer and business information sources. The questions can include elements from the user's financial history. The user then completes and submits the multiple-choice questionnaire form.” Third, “[a] series of algorithms are run comparing the consumer-supplied information to the datasources, and the consumer responses to the multiple-choice questionnaire to determine if the person is who he or she claims to be. If the engine can verify the user's identity, the user moves to the next step in the customer-defined application process. If eIDverifier cannot verify the identity, the user is directed to complete the identity verification process manually. Because customers themselves establish which score level is accepted, they can raise their level of fraud protection as high as they need it to be.”

RocketBridge (www.rocketbridge.com) markets an authentication product called Jupiter (see http://www.internethealthcaremag.com/ html/news/NewsStory.cfm?DID=5423). To verify an individual's identity, the company asks typical “credit card application” questions such as the person's name, date of birth and social security number. It also asks financial questions, with the person's consent, about mortgages, automobile loans and credit card balances, and then compares the user's answers with information on the user from Trans Union's credit files. Although the answers to the latter set of questions is harder for an attacker to come by, they suffer the difficulty that precise financial amounts are hard for some users to remember and are not easily answered with information carried in a wallet or purse.

The eIDverifier product from Equifax Secure and the Jupiter product from RocketBridge base their authentication schemes on “secret” personal information. This personal information is to a large extent information stored in proprietary databases belonging to the credit bureaus —Equifax and Trans Union, respectively. In these applications, the user does not create the questions or the answers. Instead, the verifier creates the questions and answers. The “secret” personal information, although in some respects similar to personal entropy, is in reality not personal entropy since the data, while individual, do not meet the standard of not being present in an external database.

In particular, the personal information used by these applications does not meet the PE standard of using data not likely to be available to competent private investigators (PIs). Credit Bureau information is available on a fee per use or subscription basis, including offline CD sets, to any who attest to a suitable business need and pay the requisite fees. PIs and others with access can make use of this data for any purpose. Although users of these databases stipulate to numerous checks on their usage, in reality these checks are unenforceable when offline data sets are involved, and are hard to enforce when subscription from a large customer is used. Hence, it would be more accurate to describe the personal information used to authenticate users in Credit Bureau information based authentication applications as “privileged information”, since special privilege is required to access the data. And, while authentication systems that utilize such “privileged information” may look like PE systems, they are not, since a competent PI can break them with ease by abuse of privilege. Also, such systems place a much greater burden on the user, since most people do not remember exactly how much their mortgage payment is or their paycheck amount is, and these items should be given to all significant digits.

Ellison et al. refer to an implementation they developed called SynCrypt. This is a product developed by SynData Technologies, Inc. A news release entitled “SynCrypt Promised Pain-Free Crypto”, dated Apr. 6, 1998, provides information about SynCrypt (see http://www.wired.com/news/print/0,1294,11484,00.html). The news release states that “SynCrypt 1.2 . . . uses an innovative ‘personal passphrase recovery’ scheme for those users who might forget their passphrase. We encrypt your key in the answers to a bunch of very personal questions,” said Schneier, “When you set up this feature, you are asked things you are not likely to forget, such as ‘Where did you lose your virginity?’ ‘What was your favorite candy bar as a kid?’, ‘What was the color of your first car?’, and other stuff you are not likely to forget. A high score—25 out of 27—will reveal the passphrase.” In this PE system, the verifier creates the PE questions and the user creates the PE answers. This method, and its usability and entropy shortcomings, has already been described previously.

Intel Authentication Services (IAS) provides yet another example of a product that implements PE. IAS “offers online healthcare service providers real-time, managed authentication and usage monitoring, multiple identity confirmation levels and a highly scalable and secure solution for authenticating their online transactions” (see Intel Internet Authentication Services: The AMA Internet ID Service, copyright 2000 Intel Corporation, at URL http://www.intel.com/internetservices/security/Ref_Center/IAS-CIO_WP_final_IIAS101.02.pdf.). IAS incorporates flexible certificates for roaming access. The Intel document states, “When a physician is issued an AMA Internet ID, a roaming certificate and roaming private key are also created. Roaming certificates are securely stored in the Intel IAS database. The user's roaming passphrase protects the roaming private key. When authentication is requested from a computer that does not contain a fixed private key, the physician is presented with a personalized set of roaming questions. The answers to these questions are the user's Roaming Passphrase. Once the questions are answered correctly, the wrapped roaming private key is downloaded from the Intel IAS database. Authentication the proceeds normally.” In early 2001, it is understood that Intel sold certain assets of its Internet Authentication Services and licensed Intel-developed authentication technology to VeriSign.

In addition to the desirable features of a PE System already described and discussed, there are, in fact, other desirable features that can be identified.

It would be desirable to provide an “answering algorithm” wherein users are required to answer only a subset of the total number of PE questions and answers in order to recover the correct PE Secret, i.e., to initially provide answers to only m of the n total questions. But, in this case, the user would have a choice of the questions that will be answered, and it would be a useful feature for the “answering algorithm” to help the user remember which questions he or she is mostly likely to answer correctly. To accomplish this, the user's computer system (i.e., client) could keep track of how frequently and recently a question has been answered correctly and incorrectly, and this information could be stored and then displayed to the user each time the user attempts to recover his or her PE Secret. In this way, the user could easily see which questions have presented the least and most trouble over time. Therefore, it would be useful for the PE system to combine frequency and time-related statistics and for the “answering algorithm” to prominently flag the m questions most likely to be answered correctly on the current attempt, as well as display the statistics themselves.

An additional and useful property of displaying the statistics is the opportunity such display affords the diligent user to notice and report an attack based on unusual statistics. For example, an unusual number of failures might be indicated on a question the user knows is usually answered properly. If the date and time of recent successful attempts is also available to the user, then the user can determine whether the attack was successful. This illustrates once again how PE differs from other security systems in requiring and leveraging the active participation of the user to achieve both significantly higher entropy in user remembered secrets (versus passwords and passphrases) and to detect and report attacks and potential system compromises.

Moreover, it would be desirable to provide an even more optimal “answering algorithm” affording an even more efficient and useful PE system and offering a high level of security and protection from attack.

### SUMMARY OF THE INVENTION

It is therefore an object of the present invention to provide a PE answering algorithm that minimizes the time and effort that a user must expend to recover his or her PE secret.

It is another object of the invention to provide a PE answering algorithm that is robust and that addresses problems associated with user memory blocks.

It is a further object of the invention to provide a PE answering algorithm that minimizes the user's effort and time, including the number of questions and answers (Q&As) to be created, the number of questions answered, the time required to recover a user's PE secret, the number of user keystrokes to recover the user's PE secret, and the number of failed attempts to recover the user's PE secret.

It is yet another object of the invention to provide a PE answering algorithm that addresses the problem of Q&As where words in answers have no implied ordering.

It is yet a further object of the invention to provide a PE answering algorithm that enables the PE system to detect likely “guessing attacks,” i.e., where an attacker, masquerading as a user, is attempting to guess the answers to the user's PE questions.

It is still another object of the invention to provide a PE answering algorithm that minimizes the number of per-session trials that an attacker can perform via a “guessing attack”.

It is still a further object of the invention to provide a method that is fault tolerant, which permits a user's PE secret to be recovered even if one or more of the PE answers is incorrect.

Yet another object of the invention is to provide a PE answering algorithm that permits usage information to be collected about correct, potentially incorrect, and incorrect answers, and in some cases the nature of the error (key stroke error or juxtaposition of words in an answer or totally incorrect answer).

U.S. patent application Ser. No. 09/8 83,43 1 and U.S. patent application Ser. No. 09/8 83,44 1, describe a Personal Entropy (PE) system in which a user creates “n” PE questions and answers (Q&As) in a Create PE fuinction, and these Q&As are in turn used to encrypt and a user PE secret. To recover the PE secret, the user provides answers to only “m” of the “n” questions (m≦n) in a Recover PE fuinction, where the user selects the subset of “m” questions to be answered and the “m” Q&As are then used to decrypt and recover the user's PE secret.

The processes of selecting or specifying questions to be answered, providing answers, and processing these Q&As to recover the user's PE secret, are embodied in an algorithm, hereinafter referred to as a “PE Answering Algorithm.” The PE answering algorithm described in U.S. patent application Ser. No. 09/883,43 1 and U.S. patent application Ser. No. 09/883,441 has the advantage that it minimizes the number of potential answers that a PE user must provide (typically by typing the answers at a keyboard) and it lets the user select a subset of “m” questions that s/he feels most confident in answering correctly. As one can see, this answering strategy focuses primarily on minimizing the “work” of the user, since it requires only “m” of “n” questions to be answered. Additionally, since users select the “m” questions to be answered, the answering strategy addresses the potential problem of “memory blocks.” Also, it increases the probability that a correct PE secret is recovered on a per session basis, with the overall effect of reducing the “work” of the user.

U.S. patent application Ser. No. 09/883,431 and U.S. patent application Ser. No. 09/883,441 also specify that an error recovery mode can be entered in the event that the user fails to provide “m” correct answers for the “m” (m<n) selected questions. The error recovery mode gives the user an opportunity to provide answers to remaining unanswered questions or to provide different or corrected answers to previously answered questions. In a PE system, the rules for selecting questions and providing answers is embodied in an algorithm called the “PE answering algorithm.”

The reader will appreciate that many possible strategies exist for designing a “PE answering algorithm,” and that the method described in U.S. patent application Ser. No. 09/883,431 and U.S. patent application Ser. No. 09/883,441 represents only one possible “PE answering algorithm.” For purposes of discussion, a “PE answering algorithm” could be viewed as consisting of (1) an initial step in which the user selects a portion or all of the questions and provides answers to these questions, and (2) one or more subsequent steps in which the user is given an opportunity to select a portion or all of the unanswered questions and provide answers to these questions, or to change answers for previously selected questions, or both. More particularly, during the initial step, the user answers a number of questions (‘j’), where j can be as small as “m” or as large as ,n (i.e., m≦j≦n). The questions could be selected by the user or by the system or both. During subsequent steps, which addresses the case where the user fails to provide “m” correct answers during the initial step, the user is given an opportunity to provide answers to additional questions or previously answered questions or both. Again, the questions could be selected by the user or by the system or both.

There are several possible factors that could be considered in designing an optimal PE answering algorithm, including the following:

Memory block

A user may be unable to recall the answer to a question due to a “memory block.” Sometimes a name, place or date that we know can totally escape us. Try as we might, we just can't remember it. Then, for no apparent reason, a few minutes later the answer pops into our mind. We call this a memory block, since our memory is temporarily blocked. A memory block may only be temporary, in which case a memory block doesn't necessarily mean that the user has forgotten the answer altogether. Thus, a Q&A that the user avoids during a PE session, due to a memory block, may be selected and used during another session. Of course, if a user encounters an unusually high number of memory blocks for the same Q&A, it might be wise for the user to change that Q&A.

Answers With No Implied Order

It is possible for a user to create a Q&A such that the words comprising the answer have no implied order. If the PE system requires the user to demonstrate the correct order of these words, then the PE secret will not be generated if the correct words are entered in the wrong order. It is easy to construct examples in which there is an implied ordering of the words in an answer (e.g., first and last name; city and state; month, day and year). However, it is also easy to construct examples where the words in an answer have no implied ordering. For example, the question “Who where two boyhood friends?” could have the answer “Flick” and “Schwartz”. But there is no easy way to determine whether the correct order is “Flick” and “Schwartz” or “Schwartz” and “Flick.”

Keystroke Errors

An incorrect answer can occur as the result of incorrectly typing one or more of the words in the answer. Note that the assumption made here is that the user enters his or her answers at a keyboard. An entry error can occur because an incorrect letter is typed. For example, the user may intend to type the word “Dorothy” but instead type “Corothy”. An entry error can also occur as a result of a character being accidentally omitted (e.g., the “r” in “Dorothy” is omitted to give “Doothy”) or as a result of an extra character being accidentally inserted (e.g., the “r” in “Dorothy” could be pressed twice to give “Dorrothy.”Generally speaking, the greater the number of keystrokes made by the user the greater the number of keystroke errors made by that user. Therefore, it is desirable for the PE system to minimize the number of required user keystrokes. It is also desirable for the PE system to assist or help users to detect mistakes or errors in their entered answers.

User Effort

The more “work” required of the user, the more likely it is that the user will make mistakes, and therefore the more likely it will be that the user becomes frustrated with the PE system. Hence, the PE system should be designed to reduce the time and effort that users must expend to recover these PE secrets. In particular, the PE answering algorithm should be designed to minimize the number of questions that must be answered, in order for the PE secret to be recovered.

Detecting Guessing Attacks

It would be advantageous if the answering algorithm could detect “guessing attacks.” A guessing attack is an attack in which the attacker masquerades as another user and attempts to be authenticated as that user by correctly guessing the answers to at least “m” of the user's Q&As.

Defending Against Guessing Attacks

While it is unlikely that we can eliminate the threat from guessing attacks, the PE answering algorithm should be designed to reduce the threat from guessing attacks. If users could always to counted on to remember the answers to their PE questions, then an optimal PE system design would be one where users create “m” Q&As and provide these “m” answers each time their PE secret is to be recovered. However, users may sometimes forget the answers to questions, and therefore a fault tolerant design in which users provide answers to more than m questions and the PE secret is recovered using only m answers, is inherently more practical. In this case, allowing the user to be authenticated on the basis of any one of several possible combinations of m answers (called a trial) increases the user's chances of being successfully authenticated. For example, if there were 10 ways to produce combinations of m answers, then 10 trials per session could be used by an attacker to perpetrate a “guessing attack.” Thus, the PE answering algorithm must implement a fault tolerant design that ensures valid users will be successfully authenticated with high probability, yet limits and minimizes the number of trials per session that can be used by an attacker to perpetrate a “guessing attack.”

Computation, Transmission, and Storage

The PE answering algorithm should not require inordinate computational and storage resources and transmission times.

PE Answers of High Entropy

The PE answering algorithm should, of course, enable users to provide PE answers of high entropy.

According to the present invention, the PE answering algorithm enables a user of a computing system to generate secret values from answers to questions previously created by the user. The questions which were previously created by the user are displayed to the user on a user interface (UI), and the user is prompted to select a subset of the questions to answer. When the user provides answers for the selected subset, an attempt is made to generate the secret value from a portion of the subset and possibly other information. If the secret value cannot be generated from at least a portion of the selected subset and possibly other information, the user is prompted to select a second subset of the displayed questions and provide answers to the selected second set of questions. When the user provides answers to the second selected subset of questions, an attempt is made to generate the secret value from a portion of the first and second sets of answers and possibly other information.

The PE answering algorithm is implemented on the computing system using basically three components. These are the PE-controller server computer, the PE-user client controller and the PE-authentication server computer. These three components are interconnected via a network, such as the Internet. Attached to the PE-controller server is a repository of downloadable client applets. The client applets are downloaded to the PE-user client controller and used for both creating the secret value from answers supplied by the user when creating the questions in the create PE process and, later, in the recover PE process, generating the secret value from answers provided by the user to subsets of the previously created questions. The PE-authentication server computer maintains a central database where PE information created by PE users can be stored and subsequently accessed by the PE-controller server computer on behalf of the PE user. The PE-authentication server computer also performs a user authentication service.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the components of a PE system in accordance with an embodiment of the present invention;

FIG. 2 is a block diagram of a PE system in accordance with an embodiment of the present invention;

FIG. 3 is a block diagram of a PE-authentication server computer database in accordance with an embodiment of the present invention;

FIG. 4 is a block diagram of the PE fields for PE user with identifier ID, in accordance with an embodiment of the present invention;

FIG. 5 is a block diagram of the functional modules in a PE system in accordance with an embodiment of the present invention;

FIG. 6 is a block diagram of a PE client applet incorporating all functional modules in accordance with an embodiment of the present invention;

FIG. 7 is a block diagram of a PE client applet communicating with a security function client applet via a secure communication path in accordance with an embodiment of the present invention;

FIG. 8 is a block diagram of a security function client applet consisting of PE functional modules and security function functional modules in accordance with an embodiment of the present invention;

FIG. 9A is a block diagram of a PE-user client computer with an embedded PE client applet connected to the Internet in accordance with an embodiment of the present invention;

FIG. 9B is a block diagram of a PE-user client computer with an embedded security function client applet connected to the Internet in accordance with an embodiment of the present invention;

FIG. 10 is a flowchart of the steps in a typical PE session in accordance with an embodiment of the present invention;

FIGS. 11A and FIG. 11B, taken together, are a flowchart of processing steps performed by a Create PE function in accordance with an embodiment of the present invention;

FIGS. 12A and FIG. 12B, taken together, are a flowchart of processing steps performed by a Recover PE function in accordance with an embodiment of the present invention;

FIGS. 13A, 13B and 13C, taken together, are a flowchart of processing steps performed by a first embodiment of a PE answering algorithm in accordance with an embodiment of the present invention;

FIGS. 14A, 14B, 14C, and 14D, taken together, are a flowchart of processing steps performed by a second embodiment of a PE answering algorithm in accordance with an embodiment of the present invention; and

FIG. 15 is a flowchart of the steps in a typical PE session, in which the Recover PE function has a PE answering algorithm based on correctly answering “m” or “m+1” or “m+2” PE answers determined by the PE system.

### DETAILED DESCRIPTION OF A PREFERRED

### EMBODIMENT OF THlE INVENTION

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

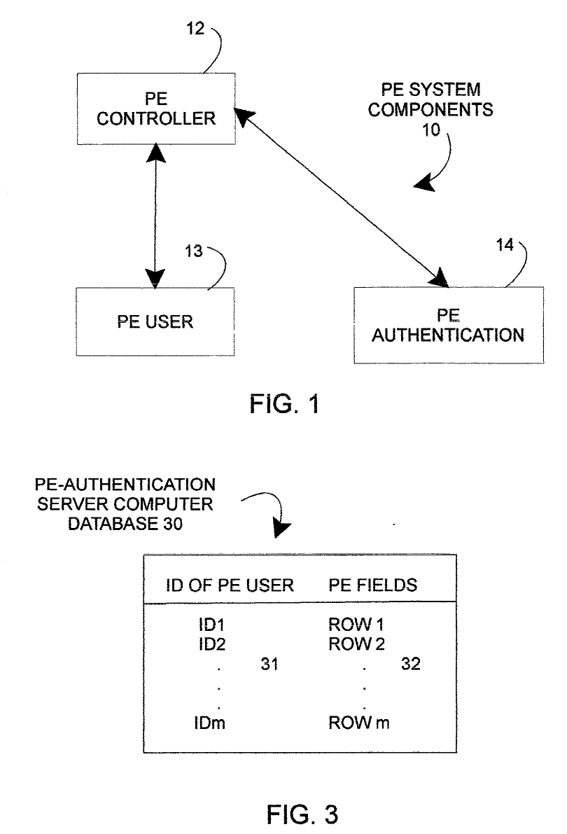

Referring now to the drawings, and more particularly to FIG. 1, there is shown a block diagram depicting the components of a PE system 10, in accordance with a preferred embodiment of the present invention, consisting of at least one PE user 13 component, a PE controller 12 component, and a PE authentication 14 component. The PE controller 12 manages the PE system program code, dynamically provides PE system program code to PE users' computer systems, collects statistics on the operation of the PE system, and in turn uses the statistical data to effect changes to the PE system, including the PE system program code. The PE authentication 14 component maintains a central database where PE information created by PE users can be stored and subsequently accessed by the PE controller (on behalf of the PE user). The PE authentication component also performs a user authentication service.

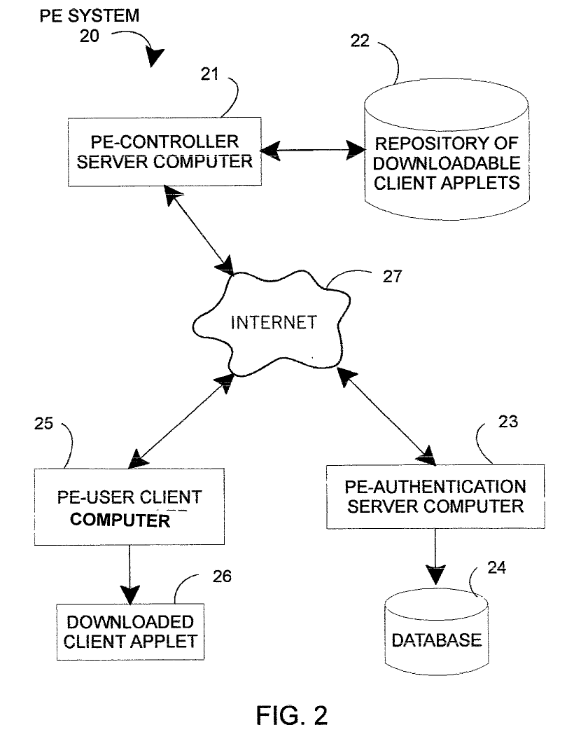

FIG. 2 is a more detailed block diagram of a PE system 20 consisting of a PE-controller server computer 21 with an associated repository 22 of downloadable client applets, an PE-authentication server computer 23 with an associated database 24 with information associated with specific users, and at least one PE-user client computer 25, which is running a downloaded PE client applet 26. In the preferred embodiment, the PE-controller server computer 21, the PE-authentication server computer 23, and the PE-user client computer 25, are connected to a communications network such as the Internet 27. Although communications between the PE-user client computer 25, PE-controller server computer 21, and PE-authentication server computer 23 preferably take place over the Internet 27, the present invention is not limited to use of the Internet 27, but may be practiced on any communications network, or even as a “stand-alone” on a single platform.

Referring to FIGS. 1 and 2, the services provided by the PE controller 12 are performed by a server computer connected to the communications network, called the PE-controller server computer 21, the services provided by the PE authentication component 14 are performed by a similar server computer (e.g., an authentication server) connected to the communications network called the PE-authentication server computer 23, and the services available to the PE user 13, and that can be requested by the PE user, are performed at a client computer connected to the communications network called the PE-user client computer 25.

In the preferred embodiment of the PE system, PE users can be roaming users. That is, PE users can interact with and make use of the PE system through any one of a plurality of PE-user client computers connected to the communications network. The roaming user feature is made possible because the PE information created by PE users is stored in a central database (i.e., at a PE-authentication server computer) that can be accessed from any PE-user client computer connected to the communications network.

FIG. 3 is a block diagram illustration of a PE-authentication server computer database 30 consisting of a plurality of users' PE rows denoted Row 1, Row 2, . . . , Row m32. Each Row is stored in the PE-authentication server database under the ID 31 (or mapped value) of the respective PE user, i.e., Row 1 is stored under ID_{1,} Row ₂ is stored under ID_{2,} and so forth. By providing an ID (or mapped value) to the PE-authentication server computer, a PE user with, say, ID=ID, can read and update Row “i”.

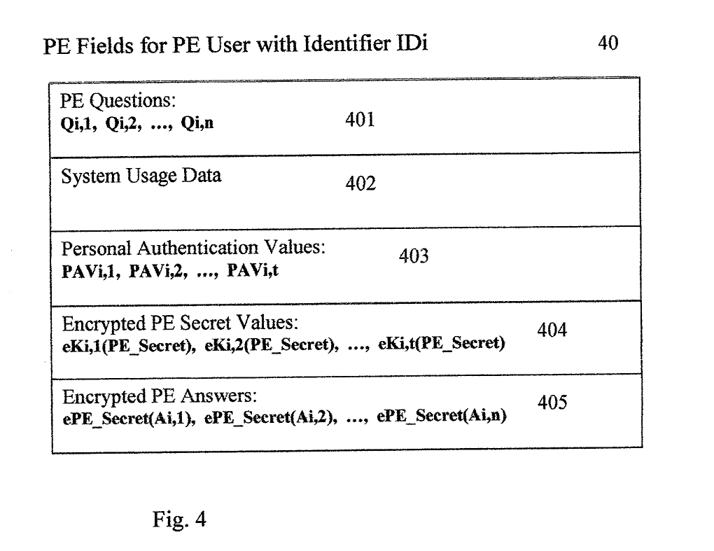

FIG. 4 is a block diagram illustration of the PE fields 40 for PE user with identifier ID, in row “i” of PE-authentication server computer database 30 of FIG. 3, comprising PE questions 401, system usage data 402, personal authentication values 403, encrypted PE secret values 404, and encrypted PE answers 405. PE questions 401 consists of “n” questions denoted Q_{l,1}, Q_{l,2}, . . . , Q_{i,n}. System usage data 402 consists of usage data collected by the PE system on PE user with identifier ID, during PE sessions, i.e., during times when the PE user interacts with the PE system. Personal authentication values 403 consists of “t f” values denoted PAV_{i,1}, PAV_{i,2}, . . . , PAV_{i,t}, where “t” denotes the number of different combinations of m Q&As in the set of n Q&As used to authenticate the user and used to decrypt and recover the user's PE secret. The number of combinations of n elements taken m at a time, denoted by symbol nCm, is computed with the formula

nCm=n!/m!(n-m)!,

where r factorial (denoted r!) is given by the formula

r!=r×(r-1)×. . . ×2×1

For example, if there are nine Q&As (n=9) and user authentication is based on five Q&As (m=5), then the number t of different values of PAV is computed as follows:

t=9!/5!(9-5)!=9!/5!4!=(9×8×7×6)/(4×3×2)=126

Encrypted PE secret values 404 consists of t encrypted values denoted eK_{i,1}(PE_Secret), eK_{1,2}(PE_Secret), . . . , eK_{i,t}(PE_Secret). The notation Y=eK(X) denotes the encryption of plaintext X under key K, where Y is the so-produced ciphertext. The notation X=dK(Y) denotes the decryption of ciphertext Y under key K, where X is the decrypted and recovered plaintext. Encrypted PE answers 405 consists of n encrypted answers denoted ePE_Secret(A₁), ePE_Secret (A₂), . . . , ePE_Secret(Aₙ). For convenience, the above variables may sometimes be indexed without reference to a particular user. For example, the variables associated with a generic PE user may be described simply as:

PE Questions: Q₁, Q₂, . . . , Qₙ

Personal Authentication Values: PAV₁, PAV₂, . . . , PAVₜ

Encrypted PE Secret Values: eK₁(PE_Secret), eK₂( PE_Secret), eKₜ(PB_Secret)

Encrypted PE Answers: ePE_Secret(A₁), ePE_Secret (A₂), . . . , ePE_Secret(Aₙ)

In the preferred embodiment of the present invention, the PE Secret is a secret value randomly generated by the PE system. Once generated, the PE Secret is used as a cryptographic key to encrypt the user's “n” answers A₁, A₂, . . . , Aₙ to produce encrypted PE Answers ePE_Secret(A₁), ePE_Secret(A₂), . . . , ePE_Secret(Aₙ) 405 and the PE Secret is encrypted under each of the user's “t” cryptographic keys K₁, K₂, . . . , Kₜ to produce encrypted PE Secret Values eK₁(PE_Secret), eK₂(PE_Secret), eKₜ(PE_Secret) 404.

In the preferred embodiment of the present invention, personal authentication values PAV_{i,1}, PAV_{l,2}, . . . , PAV_{l,t}, and cryptographic keys K_{t,1}, K_{1,2}, . . . , K_{l,t} for each user “i” are computed with two different functions F₁ and F₂, as follows: PAV_{l,J}=F₁(j-th subset of questions drawn from set {Q_{l,1}, Q_{i,2}. . . Q_{l,n}}, j-th subset of answers drawn from set {A_{l,1}, A_{l,2}. . . , A_{i,n}}, Other Information) K_{lJ}=F₂(j-th subset of questions drawn from set {Q_{l,1}, Q_{l,2}, . . . , Q_{l,n}}, j-th subset of answers drawn from set {A_{l,1}, A_{l,2}, . . . , A_{l,n}}, Other Information)

In the preferred embodiment of the present invention, the subset of questions/answers would consist of m or m+1 questions/answers, and there would be a different combination of “m” or “m+1” questions/answers for each of the “t” subsets of questions/answers used to compute PAV_{iJ}, and Kₗⱼ. The answers in {A_{l,1}, A_{l,2}, . . . , A_{l,n}}” are the answers corresponding to the questions in {Q_{l,1}, Q_{l,2}, . . . , Q_{l,n}}”. Likewise, the j-th subset of answers drawn from set {A_{l,1}, A_{l,2}, . . . , A_{l,n}} are just the answers corresponding to thej-th subset of questions drawn from set {Q_{l,1}, Q_{l,2}, . . . , Q_{l,n}}.

An example of suitable functions F₁ and F₂ would be this: (1) alternatively concatenate the answers in the “j-th subset of answers drawn from set {A_{l,1}, A_{l,2}, . . . , A_{l,n}}” with the questions in the “j -th subset of questions drawn from set {Q_{l,1}, Q_{l,2}, . . . , Q_{l,n}}”, post-pend “other information” if such other information exists and is intended to be used, and pre-pend a header H₁ or H₂ depending on whether the function computed is F₁ or F₂, respectively, where H₁ and H₂ contain identifying information that distinguishes function F₁ from function F₂, and then (2) hash the resulting concatenated information string using a cryptographic hash function such as the Secure Hash Algorithm (see Schneier, Applied Cryptography, pp. 442-445). To illustrate, suppose that the “j-th subset of questions drawn from set {Q_{l,1}, Q_{l,2}, . . . , Q_{l,n}}” consists of the following five questions {Q₁, Q₂, Q₃, Q₄, Q₅} arranged in canonical order and the “j-th subset of answers drawn from set {A_{l,1}, A_{l,2}, . . . , A_{l,n}}” consists of the corresponding five answers {A₁, A₂, A₃, A₄, A₅}. The concatenated strings S₁ and S₂ used in the computation of functions F₁ and F₂, respectively, are represented as follows:

S₁=H₁∥A₁∥Q₁∥A₂∥Q₂∥A₃∥Q₃∥A₄∥Q₄∥A₅∥Q₅∥Other Information

S₂=H₂∥A₁∥Q₁∥A₂∥Q₂∥A₃∥Q₃∥A₄∥Q₄∥A₅∥Q₅∥Other Information

where symbol “∥” denotes concatenation and “other information” is optional. In this case,

F₁({A₁, A₂, A₃, A₄, A₅}, {Q₁, Q₂, Q₃, Q₄, Q₅}, Other Information)=SHA(S₁) F₂ ({A₁, A₂, A₃, A₄, A₅}, {Q₁, Q₂, Q₃, Q₄, Q₅}, Other Information)=SHA(S₂)

Those skilled in the art will recognize that there are many possible ways to define suitable functions F₁ and F₂. Likewise, it will be recognized that the present invention is not limited to use of the functions F₁ and F₂ described above and that the invention can be practiced with any suitable functions F₁ and F₂.

The reader will appreciate that in some cases it is unnecessary to use a double indexing scheme of the values of PAV_{lJ}, and K_{lJ}, in which case the values of PAV_{lJ} and K_{lJ} can be expressed using a single indexing scheme PAV_{J}, and K_{J}, as follows:

PAV_{J}=F₁(j-th subset of questions drawn from set {Q₁, Q₂, . . . , Qₙ}, j-th subset of answers drawn from set {A₁, A₂, . . . , Aₙ}, Other Information) K_{J}=F₂ (j-th subset of questions drawn from set {Q₁, Q₂, . . . , Qₙ}, j-th subset of answers drawn from set {A₁, A₂, . . . , Aₙ}, Other Information) It is convenient to use the double indexing scheme when referring to values stored in the PE-authentication computer server database. It is likewise convenient to use the single indexing scheme when referring to values computed by the PE client applet.

Although the preferred method for protecting the PE Secret is by encrypting it under the “t” cryptographic keys K₁, K₂, . . . , Kₜ, as described above, those skilled in the art will appreciate that the method proposed by Ellison et al., based on Shamir's Secret Sharing scheme (see A. Shamir, “How to Share a Secret,” Communications of the ACM 22, No. 11, pp. 612-613, November 1979), could also be used with the present invention as an alternate means to protect the PE Secret and to enable its recovery. Shamir's Secret Sharing uses a polynomial

f(x)=a₀+a₁x+a₂x²+a₃x³+. . . +aₘ₋₁x^{m-1}modp,

where p is a prime number and “m” correct answers are required to recover the PE Secret. In this case, the PE client applet would select (m-1) independent, pseudo-random polynomial coefficients (a₁, a₂, a₃, . . . , aₘ₋₁), insert the PE Secret as the constant coefficient, a₀, and evaluate the polynomial at n different points, e.g., X₁, X₂, X₃, . . . , Xₙ, to produce n secret shares, S₁=f(X₁), S₂=f(X₂), S₃=f(X₃), . . . , Sₙ=f(Xₙ). The values X₁, X₂, . . . , Xₙ, are non-secret values and can be saved and stored within the PE system (typically at the PE-controller server computer), in order to allow the PE Secret to be recovered. Alternatively, the values of X might be the same for every PE user, and therefore these values of X could be stored in the PE client applet itself Ellison et al. suggest to compute the hash of each concatenation of question, answer, and random number R, where random number R is used as a salt, i.e.,

h₁=H(Q₁∥A₁∥R)

h₂=H(Q₂∥A₂∥R)

hₙ=H(Qₙ∥Aₙ∥R)

and then to encrypt each secret share S₁, S_{2,} etc. with the corresponding hash h₁, h₂, etc., as a key, namely: Eₕ_{₁}(S₁), Eₕ_{₂}(S₂), etc. In this case, the encrypted shares Eₕ_{₁}(S₁), Eₕ_{₂}(S2), etc., represent the PE values that allow the PE Secret to be recovered. If one wanted to encrypt the secret shares S₁, S_{2,} etc. with a 128-bit symmetric block cipher, then p should be a prime smaller than 2¹²⁸, but as close to 2¹²⁸ as possible. That is,p is also a 128-bit number. In that case, the PE Secret, the remaining polynomial coefficients, and the selected values of X can all be 128-bit numbers, provided that each such value is less then p.

To illustrate, consider the case where n=9 and m=5, in which case 15 there would be nine secret shares, S₁, S₂, . . . , S₉, and nine encrypted shares of the form Eₕ_{₁}(S₁), Eₕ_{₂}(S₂), . . . , Eₕ(S₉). If a PE user were to provide answers A₁, A₂, A₄, A₅, A₇, then the PE client applet would first compute the following hash values:

h₁=H(Q₁∥A₁∥R)

h₂=H(Q₂∥A₂∥R)

h₄=H(Q₄∥A₄∥R)

h₅=H(Q₅∥A₅∥R)

h₇=H(Q₇∥A₇∥R)

Each encrypted share Eₕ_{₁}(S₁), Eₕ_{₂}(S₂), Eₕ_{₄}(S₄), Eₕ_{₅}(S₅), and Eₕ_{₇}(S₇) would then be decrypted under its respective cryptographic key (h₁, h₂, h₄, h₅, and h₇) to recover the secret shares S₁, S₂, S₄, S₅, and S7. The secret shares S₁, S2, S₄, S₅, and S₇, and the non-secret values of X₁, X₂, X₄, X₅, and X₇ would then be used to construct five equations of the form:

S₁=a₀+a₁x₁+a₂(x₁)²+a₃(x₁)³+a₄(x₁)⁴ mod p

S₂=a₀+a₁x₂+a₂(x₂)²+a₃(x₂)³+a₄(x₂)⁴ mod p

S₄=a₀+a₁x₄+a₂(x₄)²+a₃(x₄)³+a₄(x₄)⁴ mod p

S₅=a₀+a₁x₅+a₂(x₅)²+a₃(x₅)³+a₄(x₅)⁴ mod p

S₇=a₀+a₁x₇+a₂(x₇)²+a₃(x₇)³+a₄(x₇)⁴ mod p

The m=5 equations would then be solved for the m=5 coefficients ( a₀, a₁, a_{2,} a₃, a₄) by Lagrange interpolation, where the PE Secret is the recovered value of a₀.

In the preferred embodiment of the invention, the PE-controller server computer and the PE-authentication server computer are separate server computers, as shown in FIG. 2, but they may be co-located and executed upon a single server computer, in which case there would be a single combined PE-controller and PE-authentication component and a separate PE-user component, such that the PE-controller and PE-authentication components would execute upon a single server computer and the PE user component would execute on a separate client computer.

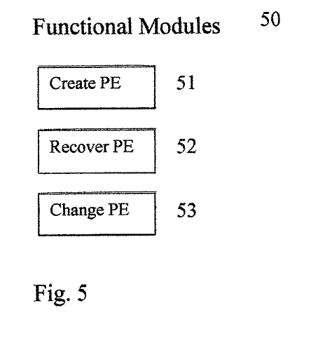

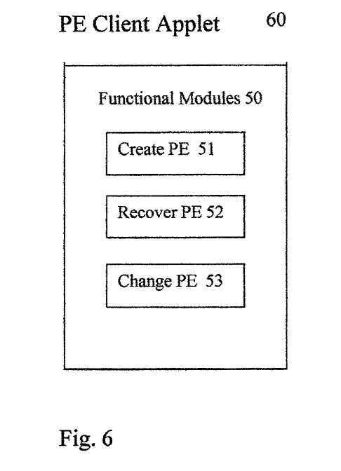

The functions provided by the PE system are depicted in FIG. 5 and FIG. 6 as Functional Modules 50. They include the following: Create PE 51, Recover PE 52, and Change PE 53. The Create PE 51 function provides a means for the PE user to create a number (n) of PE questions and answers, where n is a value that can be configured into the Create PE client applet by the PE-controller server computer 21 (FIG. 2). The Recover PE 52 function provides a means for the PE user to recover or regenerate the PE Secret (i.e., PE secret value) by selecting and correctly answering a prescribed number of the n questions created previously by the PE user using the Create PE 51 function, per the rules imposed by the PE answering algorithm. The Change PE 53 function provides a means for the PE user to change one or more of his or her PE questions and answers, or to change the PE Secret produced from the PE answers and possibly other information, or both.

Each of the PE functions (Create PE 51, Recover PE 52, and Change PE 53) can be represented as distinct and separate functional modules (FIG. 5). An Initiate PE functional module may also be beneficially employed. The Initiate PE functional module provides a set of common functions, which can be used by the other functional modules. The common functions include the following:

Provide a User Interface (UI) by which the user can request and perform any of the PE functions (Create PE 51, Recover PE 52, and Change PE 53 ).

Perform cryptographic operations on behalf of the other functional modules.

Handle the secure communications with the PE-controller server computer and the PE-authentication server computer.

Handle the secure connections with the back-end services that provide additional support to the PE functions modules.

Regardless of whether the functions performed by the Initiate PE functional module are implemented as a separate Initiate PE functional module or whether integrated into one or more of the other PE functional modules (Create PE 51, Recover PE 52, and Change PE 53 ) is unimportant. The present invention is not limited to a particular way in which the functions of the PE system are grouped or packaged into functional modules.

In one embodiment of the present invention, the functional modules (Create PE 51, Recover PE 52, and Change PE 53, including also the functions of the Initiate PE functional module) are bundled or wrapped together as a single Java Applet, or client applet, hereinafter called the PE client applet 60 (FIG. 6), and the PE client applet 60 is stored at the PE-controller server computer 21 (FIG. 2). In this case, the Client Applets at the PE-controller server computer 21 (FIG. 2) consist of a single applet, namely the PE client applet 60 (FIG. 6). A Java Applet provides flexibility in design and deployment to facilitate a user-friendly implementation, provided that the user's browser supports Java. Moreover, the use of Java substantially reduces the costs of code deployment, execution, and maintenance. In addition, deploying the functions bundled into a single Java Applet (as opposed to multiple applets communicating on the same browser) has a security benefit, since Java Virtual Machines (JVMs) do not provide Inter-Process Communications (IPC) secured against monitoring by an inappropriately modified JVM (for example, a JVM corrupted by a virus might report on the IPC of a PE applet and thereby divulge the user's PE secret to a hostile third party). By wrapping all functional modules as a single client applet, the functional modules can communicate securely using variables and function calls internal to the client applet. However, the present invention is not limited to the use of a single client applet. Alternately, the functional modules could be packaged as multiple client applets using any beneficial or optimal strategy that meets the needs or desires of the PE controller.

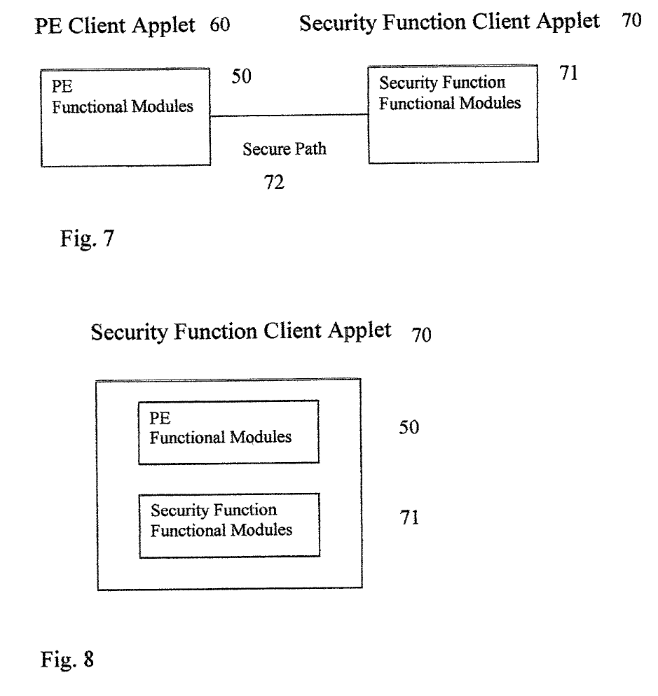

It is anticipated that the functions of a PE system will be used in conjunction with some other “using” third party's security function (mechanism, method, or protocol), which shall be assumed, without loss of generality, to also be implemented as a security function client applet 70 with associated security function fuinctional modules 71, as shown in FIG. 7. In that case, the PE client applet 60 and the security function client applet 70 must communicate via a secure path 72 in order for the PE secret generated by the PE client applet to be passed to the security function client applet.

For example, the functions performed by a PE system could be integrated into a key management system, in which case the recovered PE Secret could be utilized as a cryptographic key. A likely application suggested by Ellison et al. would be to use the generated PE Secret as a key to encrypt the private key of a public key algorithm. The encrypted private key is then stored in a central database to accommodate roaming users. In this case, the user's private key is recovered by accessing the encrypted private key from the central database, recovering the PE Secret, and decrypting the private key with the PE Secret.

In the above described application, the generated PE Secret is passed to the using security function, and therefore must be protected. A secure communication path could be established between the PE client applet 60 and the security function client applet 70 by establishing a shared secret key between the two entities using a Diffie-Hellman Discrete Logarithm public key protocol (see Schneier, Applied Cryptography, Chapter 22, pp. 513-525). However, the present invention does not preclude the possibility that implementers may find a suitable means to pass a PE Secret from the PE client applet 60 to its using security function client applet 70 without using encryption.

In another embodiment of the present invention, the PE functional modules 50 in the PE client applet 60 are wrapped together with the security function functional modules 71 of the security function client applet 70 to form a single applet called the “security function client applet”, as shown in FIG. 8. In this case, the security function client applet 70 replaces the PE client applet 60 and is stored at the PE-controller server computer 21 (FIG. 2). In an actual implementation, the role of the PE controller 12 (FIG. 1) would likely be subsumed by another entity of a different name and role, but in any case would still perform (at least in part) the finctions of the PE controller 12.

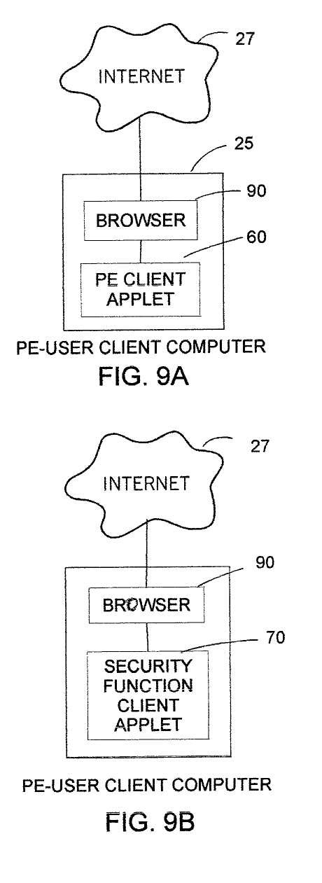

FIG. 9A and FIG. 9B are block diagrams depicting a PE-user client computer 25 connected to the Internet 27. The PE-user client computer consists of a browser 90, such as the Netscape Navigator™ or the Microsoft Internet Explorer™ browsers, and a client applet, either a PE client applet 60 (FIG. 9A) or a security function client applet 70 (FIG. 9B). The PE client applet 60 or the security function client applet 70 is distributed to the PE-user server computer when the PE user initiates a PE session or when the user invokes a using security function. Optionally, the PE client applet or the security function client applet may be signed (signing provides protection against code tampering). The PE client applet 60 or the security function client applet 70, downloaded and installed in the PE-user server computer 25 (FIG. 2), constitutes the client front-end. There is also a client back-end, not shown in FIGS. 9A and 9B, which can, as necessary, provide additional back-end services in support of the front-end.

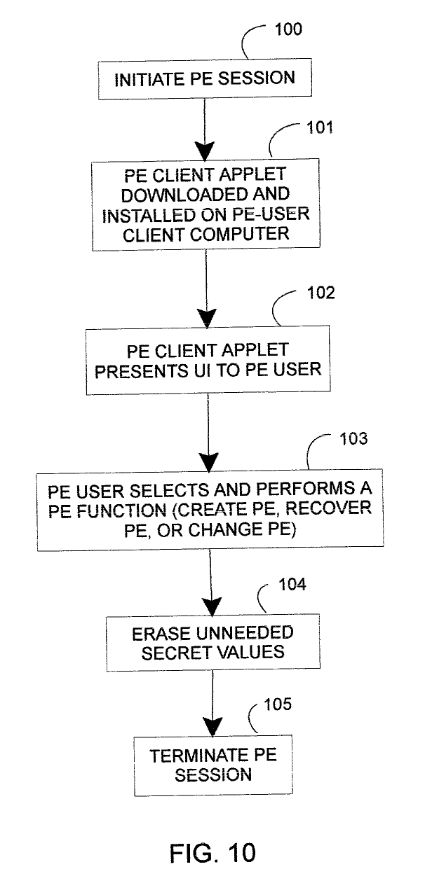

FIG. 10 is a flowchart of steps in a typical PE session. A PE user stationed at a PE-user client computer 25 (FIG. 2) equipped with a keyboard, mouse, monitor, and so forth, and with browser 90 open, initiates a PE session at function block 100 by clicking on a hyper-link (Uniform Resource Locator or URL) for the PE-controller server computer 21. In turn, the PE-controller server computer 21 (FIG. 2) causes the PE client applet, stored in the database 22 of PE-controller server computer, to be downloaded and installed on the PE-user client computer in function block 101. The PE client applet is automatically given control (i.e., executed). The PE client applet displays the User Interface (UI) (for example, various HTML (HyperText Markup Language) pages, or dynamically generated forms and graphics) to the user in function block 102. The PE user then selects and performs one of the available PE functions (Create PE, Recover PE, or Change PE) in function block 103. Any remaining unneeded secret values are overwritten and then erased (overwriting is required because JVMs use a “garbage collection” strategy which may leave sensitive values exposed for extended periods after they are nominally “deleted”) function block 104. Note that this “cleanup” step should also be carried out in each of 30 the respective PE functions. When finished, the user terminates the PE session in function block 105, e.g., by clicking on an “end” button displayed on the monitor's screen.

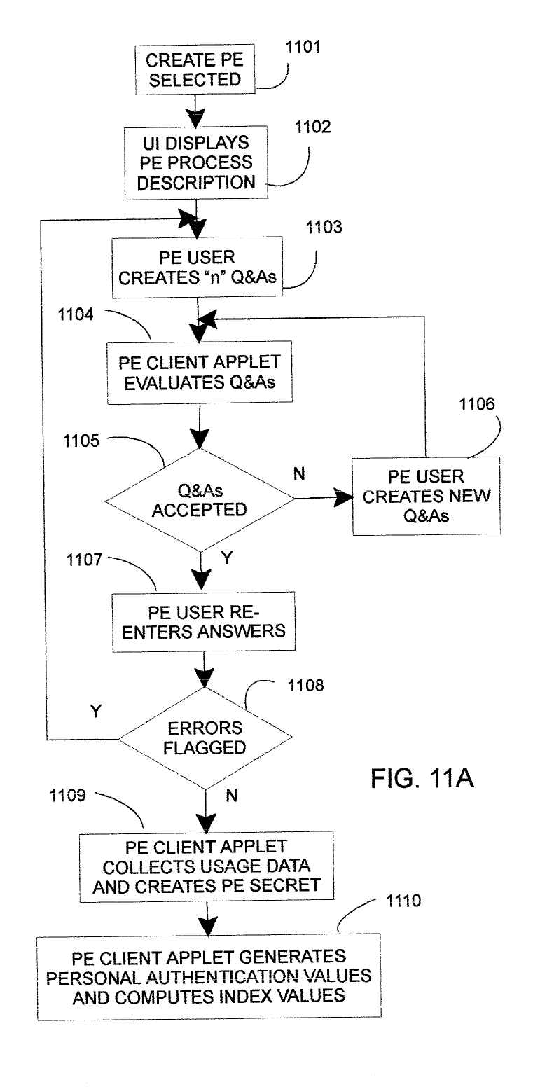

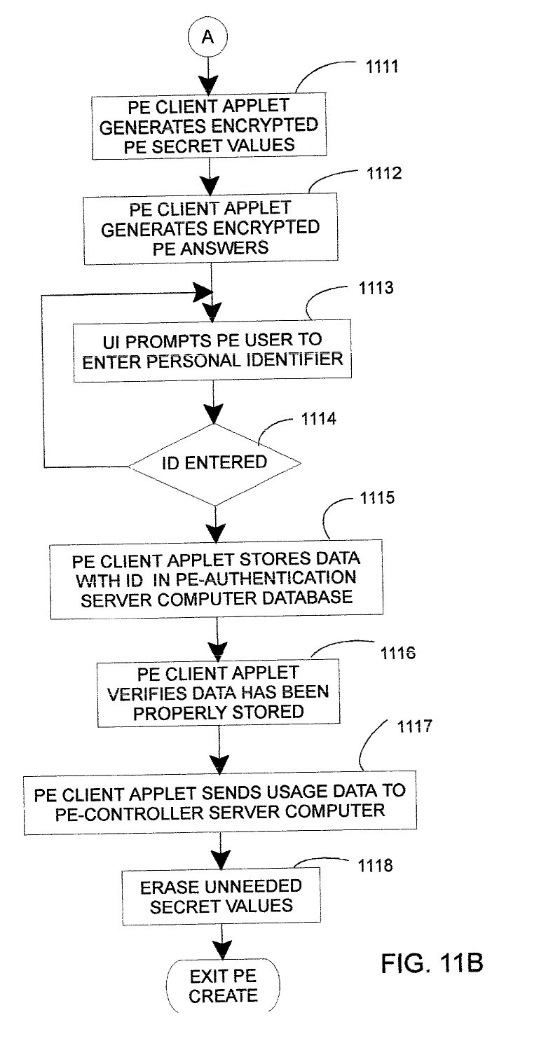

FIGS. 11 A and 11B, taken together, are a flowchart of the processing steps performed by a Create PE function 51 (FIG. 5) in accordance with the first and second embodiments of the PE answering algorithm. First, the PE user clicks on a hyper-link (URL) displayed by the UI to select the Create PE function in function block 1101. Next, in function block 1102, the UT displays a process description for the Create PE function, a set of Terms of Service, PE instructions for the Create PE function, rules for creating good PE questions and answers, and a set of examples of good PE questions and answers. Alternately, certain of the information could be displayed on different HTML pages, and the PE user may be required to click on HTML tags to cycle through the different HTML pages. Then, in function block 1103, the PE user acknowledges his or her understanding of the presented information by clicking on a “proceed to create questions & answers” hyper-link, and then by creating “n” questions and answers (Q&As). In a preferred embodiment of the Create PE function, n=9. That is, nine questions and answers are created. The PE client applet then evaluates the PE user's Q&As in function block 1104. A determination is made by the PE client applet in decision block 1105 as to whether the user's Q&As are accepted. It rejects Q&As (or possibly only answers) that are determined to be too weak. In turn, it either (1) requests the PE user to change the rejected questions and answers (or possibly just rejected answers) or it (2) informs the PE user that his or her questions and answers have been accepted. Next, in function block 1106, the PE user creates new questions and answers (or possibly just answers) to replace the rejected questions and answers (or possibly just rejected answers) if the PE client applet rejected one or more of the questions and answers (or possibly just answers) previously. Otherwise, if the PE client applet has not rejected questions and answers (or possibly just answers), then this processing step is omitted. The PE user then re-enters the answers to all “n” questions, in order to ensure that the PE user can, in fact, remember the answers to his or her questions in function block 1107. In systems supporting a combined Recover and Change PE operation and an encrypted “answer file,” only the new answers need be re-entered. Errors are flagged. The flagging of errors may be automatic or manual or a combination of both. For example, if the PE user is unable to remember the answers to some questions or if the PE user decides he or she would like to change one or more questions or answers or both, he or she is given an opportunity to do so. A determination is made in decision block 1108 as to whether errors have been flagged and, if so, the PE user is returned to the “create new questions and answers” function block 1103, and the PE user makes whatever changes he or she deems necessary. Afterwards, control passes to the “evaluate” step in function block 1104 in order that the PE client applet can again evaluate PE user's questions and answers, and then, finally, to the present step in decision block 1108. If the PE user can remember all of the answers and does not wish to make changes to the questions or answers or both (i.e., no errors are flagged), then the PE user is not returned to the “create new questions and answers” step in function block 1103. The PE client applet collects usage data on PE user's interaction with the UI in function block 1109. The term “usage data” is defined liberally to include collections of quantitative data, as well as values computed from a collection of quantitative data (e.g., the average value or mean or a sample). Those skilled in the art will appreciate that the present invention is not limited to particular usage data, in this case, and one will recognize that a variety of possible useful data and statistics could be collected, processed, and used later in order to improve the performance and usability of the UI. For example, useful usage data could be based on the following measurements: (1) the time it takes a PE user to create the required “n” questions and answers, (2) the time it takes to create each individual question and answer, (3) the time it takes to create the first, second, etc. question and answer, (4) the time it takes to create each individual question and answer, by type (e.g., depending on whether the question is a “who” question or a “what” question or a “when” question), in order to measure whether certain question types are easier or more difficult to create than others, and (5) the number and type of questions and answers that were rejected, and the reason for the rejection, and (6) the number. Next, in function block 1109, the PE client applet generates a PE Secret.

In the preferred embodiment of the invention, the PE Secret is randomly generated using a random or pseudorandom number generator. Next, in function block 1110, the PE client applet generates personal authentication values, PAV_{index}_{₁}, PAV_{index}_{₂}, . . . , PAV_{index}_{ₜ}, from PE user's provided questions and answers, and possibly other information. The PE client applet also computes the index values index₁, index₂, . . . , indexₜ. When the Create PE function is used with the first embodiment of the PE answering algorithm, the “t” values of PAV are computed from subsets of “m” Q&As, in which case t=nCm=n!/m!(n-m)!. The j-th personal authentication value, PAV_{index}_{ⱼ}, is computed, as described above, using the formula:

PAV_{index}_{ⱼ}=F₁(j-th subset of “m” questions drawn from set {Q₁, Q₂, . . . , Qₙ}, j-th subset of “m” answers drawn from set {A₁, A₂, . . . , Aₙ}, Other Information)

For example, if the PE user creates nine Q&As (n=9) and user authentication is based on five Q&As (m=5), then there are t=9C5 =9!/(5!(9-5)!)=126 different PAVs (t=126). The values of index (index₁, index₂, . . . , indexₜ) are computed using an n-dimensional array “A,” as follows:

index=A(I₁, I₂, . . . , Iₙ) where,

Iₚ=1, if the p-th Q&A is present

Iₚ=0, if the p-th Q&A is not present and the elements of array “A” range in value from 0 to t, where t=nCm=-nt/m!(n-m)!. For example, index, is computed using the first subset of“m” Q&As, index₂ is computed using the second subset of “m” Q&As, and so forth, and indexₜ is computed using the t-th subset of“m” Q&As. Array “A” is initialized as follows: (1) if I₁+I₂+ . . . +Iₙ=m, then A(I₁, I₂, . . . , Iₙ) is assigned a value from 1 to t, where each value from 1 to t occurs only once in array “A”, and (2) if I₁+I₂+ . . . +Iₙ≠ m then A(I₁, I₂, . . . , Iₙ) is assigned value zero “0.” It is assumed that the “n” Q&As have a canonical order such that, given any one of the “n” Q&A, its rank or position within the ordered list of Q&As can be easily determined. For example, the Q&A could be ordered according to the sorted order of the questions, which are arranged in ascending sequence. The first Q&A is associated with index I₁, the second Q&A is associated with index I₂, and so forth. Hence, given any subset of “m” Q&As drawn from the set of “n” Q&As, one can easily compute its index by determining the rank or position of each Q&A in the canonical list of Q&As, determining the values of I₁, I₂, . . . , Iₙ, and then accessing element A(I₁, I₂, . . . , Iₙ) in matrix “A.”

When the Create PE function is used with the second embodiment of the PE answering algorithm, the “t” values of PAV are computed from subsets of“m” and “m+1” Q&As, in which case t=t₁+t₂, where t₁=n!/m!(n-m)! and t₂=n!/(m+1)!(n-m-1)!. The j-th personal authentication value, PAV_{index}_{ⱼ}, is computed as follows:

PAV_{index}_{ⱼ}=F₁(j-th subset of “m” questions drawn from set {Q₁, Q₂, . . . , Qₙ}, j-th subset of “m” or “m+1” answers drawn from set {A₁, A₂, . . . , Aₙ}, Other Information)

For example, if the PE user creates nine Q&As (n=9) and user authentication is based on five Q&As (m=5) and six Q&As (m+1=6), then there are t=t₁+t₂32 9C5+9C6=126+84=210 different PAVs (t=210). The values of index (index₁, index₂, . . . , indexₜ) are computed using the n-dimensional array “A,” as follows:

index=A(I₁, I₂, . . . , Iₙ) where,

Iₚ=1, if the p-th Q&A is present

Iₚ=0, if the p-th Q&A is not present and the elements of array “A” range in value from 0 to t, where t=t₁+t₂, t₁=nCm=n!/m!(n-m)! and t₂=nC(m+A1)=n!/(m+1)!(n-m-1)!. For example, index₁ is computed using the first subset of “m” or “m+1” I Q&As, index₂ is computed using the second subset of “m” or “m+1” Q&As, and so forth, and indexₜ is computed using the t-th subset of“m” or “m+1” Q&As. Array “A” is initialized as follows: (1) if I₁+I₂+ . . . +Iₙ=m, then A(I₁, I₂, . . . , Iₙ) is assigned a value from 1 to t₁, where each value from 1 to t₁ occurs only once in array “A”, (2) if I₁+I₂+ . . . +Iₙ=m+1, then A(I₁, I₂, . . . , Iₙ) is assigned a value from (t₁+1) to (t₁+t₂), where each value from (t₁+1) to (t₁+t₂) occurs only once in array “A,” and (3) if I₁+I₂+ . . . +Iₙ≠m and I₁+I₂+ . . . +Iₙ, ≠m+1, then A(I₁, I₂, . . . , Iₙ) is assigned value zero “0.” It is assumed that the “n” Q&As have a canonical order such that, given any one of the “n” Q&A, its rank or position within the ordered list of Q&As can be easily determined. For example, the Q&A could be ordered according to the sorted order of the questions, which are arranged in ascending sequence. The first Q&A is associated with index I1, the second Q&A is associated with index I₂, and so forth. Hence, given any subset of“m” or “m+1” Q&As drawn from the set of “n” Q&As, one can easily compute its index by determining the rank or position of each Q&A in the canonical list of Q&As, determining the values of I1, I₂, . . . , Iₙ, and then accessing element A(I₁, I₂, . . . , Iₙ) in matrix “A.”

Next, in function block 1111 shown in FIG. 11B, the PE client applet generates encrypted PE secret values, eK₁(PE_Secret), eK₂(PE_Secret), . . . , eKₜ(PE_Secret) by first generating keys K₁, K₂, . . . , Kₜ and then encrypting the PE Secret with each key, respectively. When the Create PE function is used with the first embodiment of the PE answering algorithm, the “t” values of K are computed from subsets of “m” Q&As, in which case t=n!/m!(n-m)!. The j-th key, K&hd index_{ⱼ}, is computed as follows:

K_{index}_{ⱼ}=F₂ (j-th subset of “m” questions drawn from set {Q₁, Q₂, . . . , Qₙ}, j-th subset of “m” answers drawn from set {A₁, A₂, . . . , Aₙ}, Other Information)

The values of index (index₁, index₂, . . . , indexₜ) are computed using the n-dimensional array “A” and the equation index=A(I₁, I₂, . . . , Iₙ) in function block 1110 (FIG. 11A) under the discussion of the first embodiment of the PE answering algorithm.

When the Create PE function is used with the second embodiment of the PE answering algorithm, the “t” values of K are computed from subsets of“m” and “m+1” Q&As, in which case t=t₁+t₂, where t₁=n!/m!(n-m)! and t₂=n!/(m+1)!(n-m-1)!. The j-th key, K_{index}_{ⱼ}, is computed as follows:

K_{index}_{ⱼ}=F₂(j-th subset of“m” or “m+1” questions drawn from set {Q₁, Q₂, . . . , Qₙ}, j-th subset of “m” or “m+1” answers drawn from set {A₁, A₂, . . . , Aₙ}, Other Information)

The values of index (index₁, index₂, . . . , indexₜ) are computed in function block 1110 using the n-dimensional array “A” and the equation index=A(I₁, I₂, . . . , Iₙ) described under the discussion of the second embodiment of the PE answering algorithm.

Referring again to FIG. 11B, the PE client applet generates encrypted PE answers ePE_Secret(A₁), ePE_Secret(A₂), . . . , ePE_Secret(Aₙ) in function block 1112 by using the PE_Secret as a cryptographic key and encrypting each of the answers A₁, A₂, . . . , Aₙ, under the PE_Secret. Then in function block 1113, the UI prompts the PE user for a personal identifier. The PE user's personal identifier can be any identifier chosen by the PE user, including an anonymous identifier. Optionally, the personal identifier may either be provided by the system (without prompting the user), or may be mapped by the system to a value other than what the user provides. A determination is made in decision block 1114 as to whether the personal identifier (ID₁) has been entered, either by the PE user or by the system without the user's knowledge. The PE client applet may also optionally map the personal identifier to a different value, and this mapped value may be used instead.

When the personal identifier has been entered, the PE client applet stores the generated questions, Q₁, Q₂, . . . , Qₙ, the generated personal authentication values, PAV₁, PAV₂, . . . , PAV_{t,1}, the generated encrypted PE secret values, eK₁(PE_Secret), eK₂(PE_Secret), . . . , eKₜ(PE_Secret), and the generated encrypted PE answers, ePE_Secret(A₁), ePE_Secret(A₂), ePE_Secret(Aₙ) in the PE fields for PE user with identifier IDₗ(or mapped value) in the PE-authentication server computer database in function block 1115. To accomplish this, the PE client applet should establish a communication path with the PE-authentication server computer (preferably via the mediation of the PE Controller to allow for centralized session management), which is outside the scope of the present invention, although well understood in the present state-of-the-art. The communication path is preferably an encrypted path, i.e., the PE client applet and the PE-authentication server computer (or the PE-controller server computer on behalf of the PE-authentication server computer), could establish a common key to encrypt and protect all communications between them. The PE client applet sends the PE user's personal identifier together with the PE user's PE values (questions, personal authentication values, encrypted PE secret values, and encrypted PE answers) to the PE-authentication server computer (or to the PE-Controller server computer which optionally maps the personal identifier to another value and passes the information to the PE-authentication server computer). In turn, the PE-authentication server computer stores the PE values in a PE row “i” in the database of the PE-authentication server computer indexed by the PE-user's personal identifier ID, (or mapped value).

The PE client applet then optionally retrieves, or requests that the PE-controller server computer retrieve on its behalf, the generated PE values (questions, personal authentication values, encrypted PE secret values, and encrypted PE answers) from PE user's PE row “i” at PE-authentication server computer, stored under PE user's ID, (or a value mapped from it), to verify that the PE values have been properly stored and can indeed be recovered in function block 1116.

Next, the PE client applet sends usage data on “PE user's interaction with the UI” to PE-controller server computer, where the usage data are stored for future processing and use by PE-controller server computer in function block 1117. Finally, any unneeded secret values are overwritten and then erased in function block 1118, and the PE user exits the Create PE function.

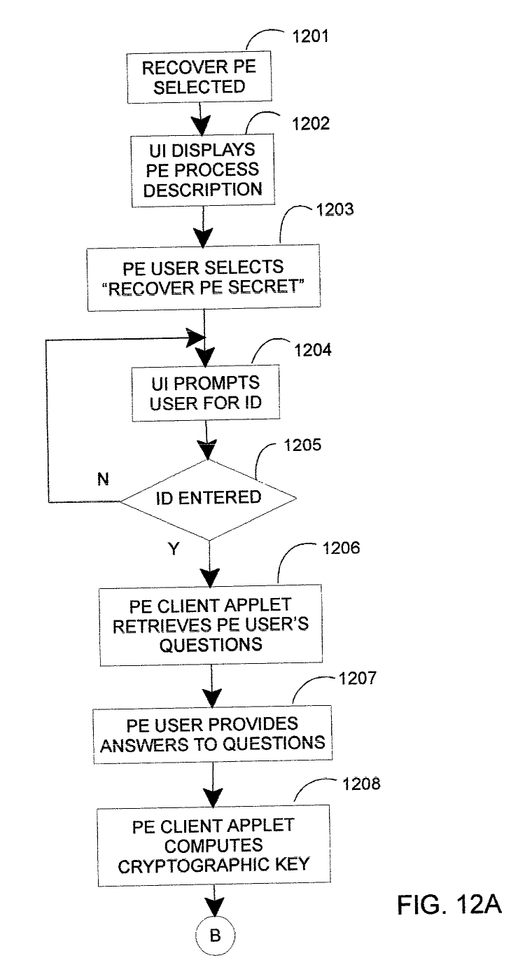

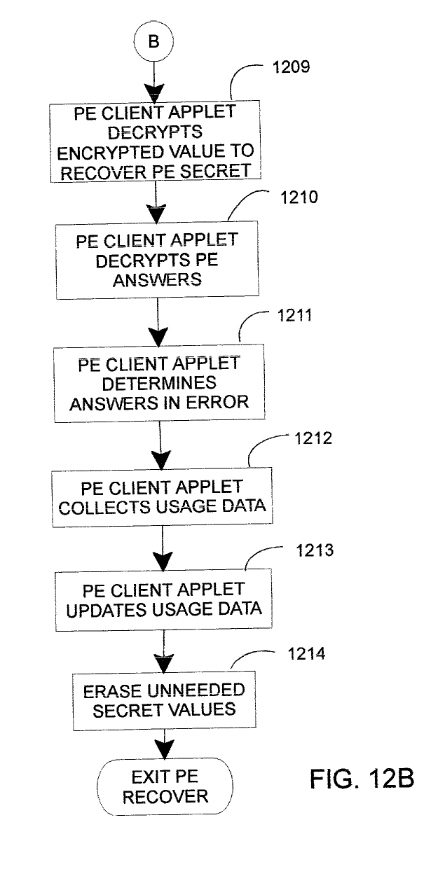

FIGS. 12A and 12B, taken together, are a flowchart of processing steps performed by a Recover PE function 52 in accordance with the first embodiment of the invention shown in FIG. 5. First, the PE user clicks on a hyper-link (URL) displayed by the UI to invoke the Recover PE function in function block 1201. Next, the UI displays a process description for the Recover PE function and a set of PE instructions for the Recover PE function in function block 1202. Alternately, certain of the information could be displayed on different HTML pages, and the PE user may be required to click on HTML tags to cycle through the different HTML pages. The PE user then acknowledges his or her understanding of the presented information by clicking on a “recover PE Secret” hyper-link in function block 1203. Next, in function block 1204, the UI prompts the PE user for a personal identifier. Optionally, the personal identifier may either be provided by the system (without prompting the user), or may be mapped by the system to a value other than what the user provides. The PE user's personal identifier can be any identifier chosen by the PE user, including an anonymous identifier, but it must be the same personal identifier that the PE user provided to the PE client applet during a prior invocation of the Create PE function. A determination is made in decision block 1205 as to whether the personal identifier has been entered.

When the PE user then enters his or her personal identifier (ID₁) or it is provided by the system without the user's knowledge, the PE client applet retrieves, or requests that the PE-controller server computer retrieve on its behalf, the previously generated PE questions, _{l,1}, Q_{1,2}. . . , Q_{l,n}, and system usage data located in the PE fields for PE user with personal identifier ID₁ (or mapped value), namely row “i”, in the PE-authentication server computer database in function block 1206. The PE client applet and the PE-authentication server computer (or PE-controller server computer on behalf of the PE-authentication server computer) may utilize an encrypted communication path, as described above under the discussion of the Create PE function (FIGS. 11A and 11B). The PE client applet sends the PE user's personal identifier (or mapped value) to the PE-authentication server computer (preferably via the mediation of the PE Controller to allow for centralized session management). In turn, the PE-authentication server computer uses the PE user's personal identifier (or mapped value) as an index to locate and retrieve the PE user's PE row, and in turn sends the recovered PE questions and system usage data (preferably via the PE-Controller) to the PE client applet. The communication path between the PE-user client computer and the PE-authentication server computer, or the paths between the PE-user client computer and PE-controller server computer and between the PE-controller server-computer and the PE-authentication server computer are preferably encrypted paths.

The PE user then interacts with the UI, providing answers to questions in accordance with the processing steps of the prescribed PE answering algorithm in function block 1207, as described in either the first or second embodiments of the PE answer algorithm, including the various described variations on the first and second embodiments.

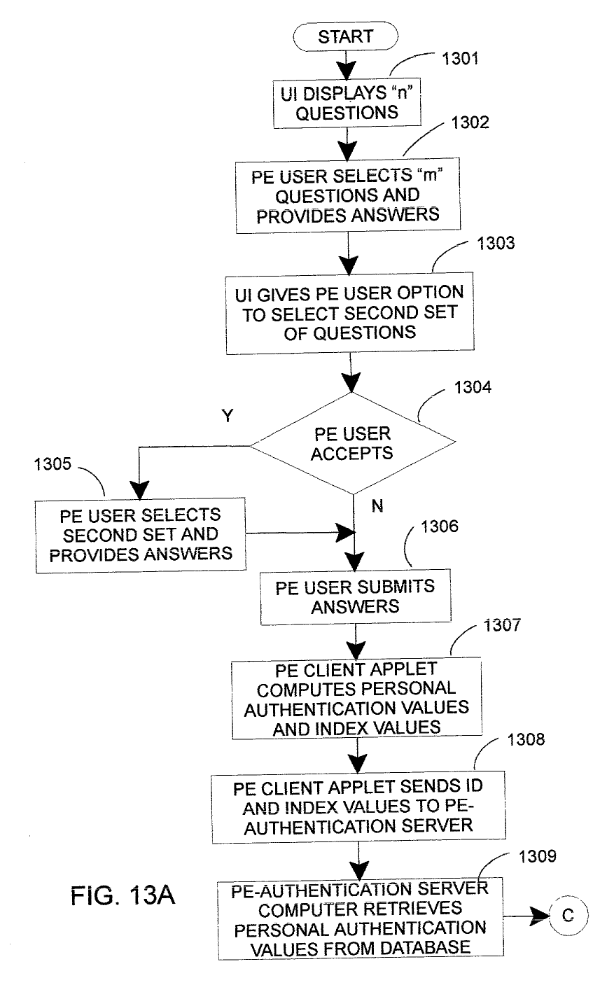

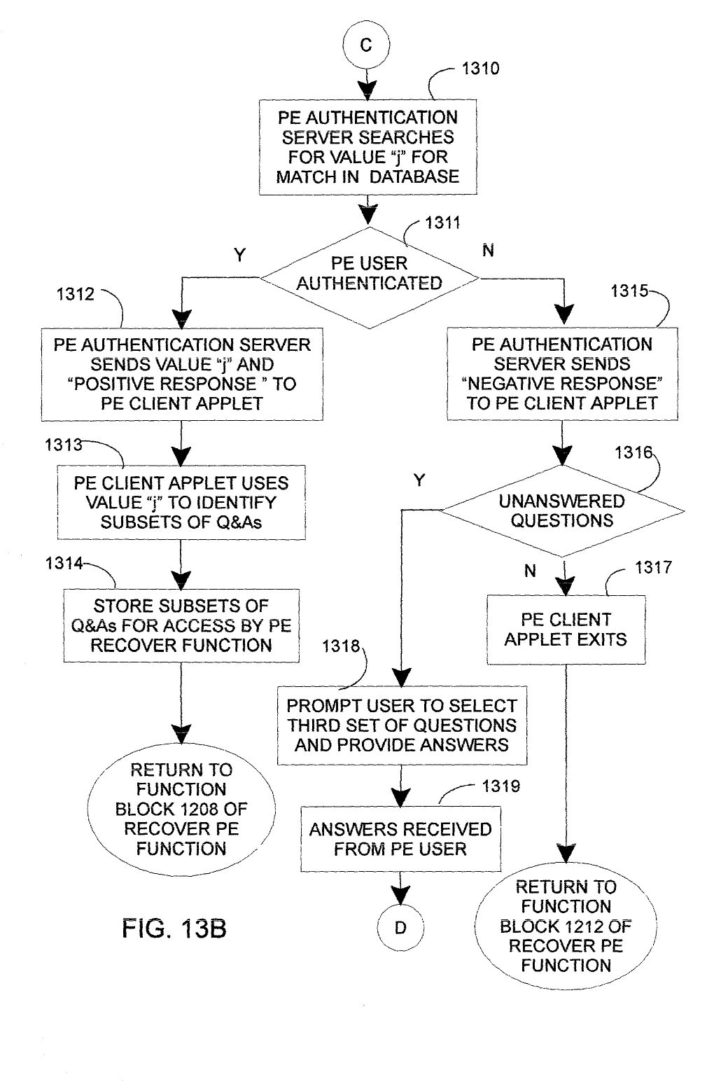

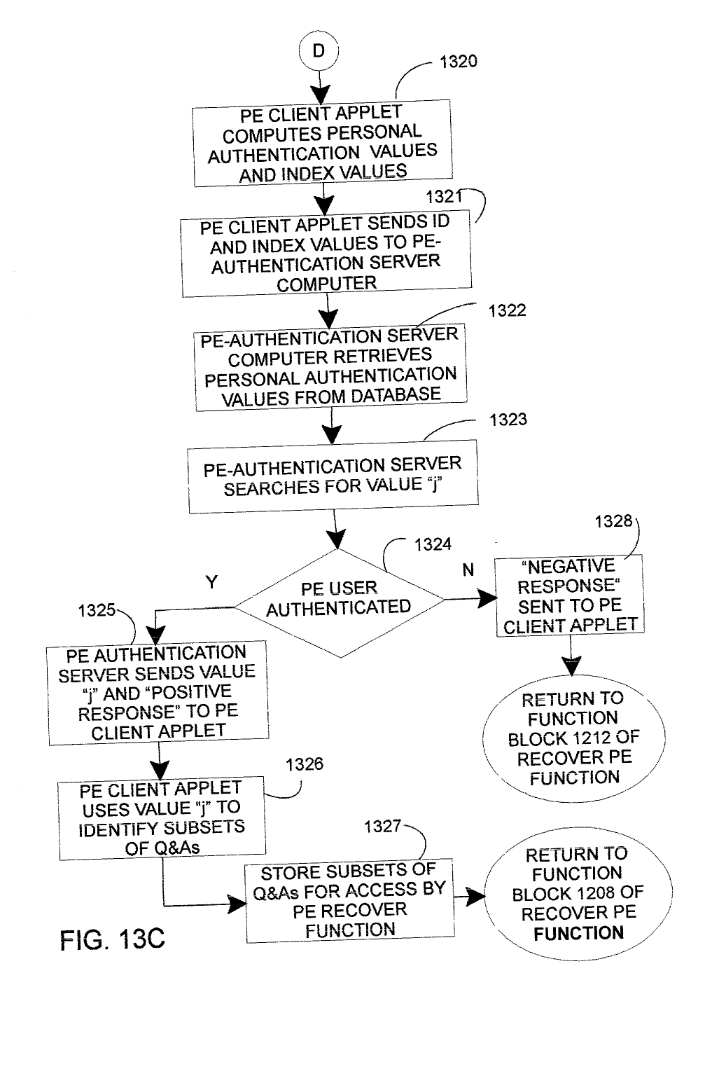

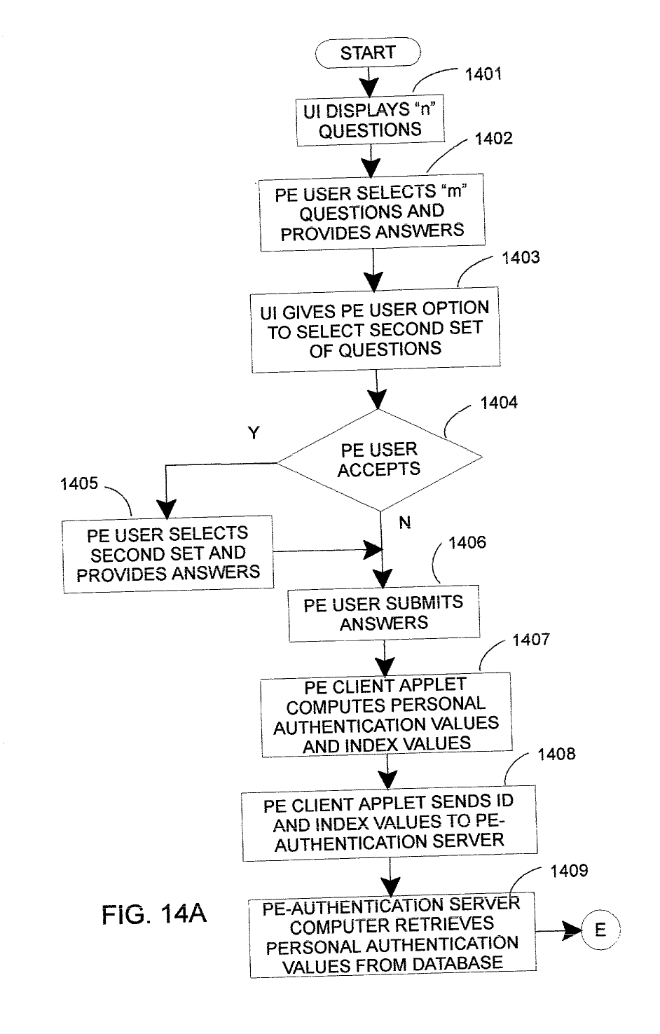

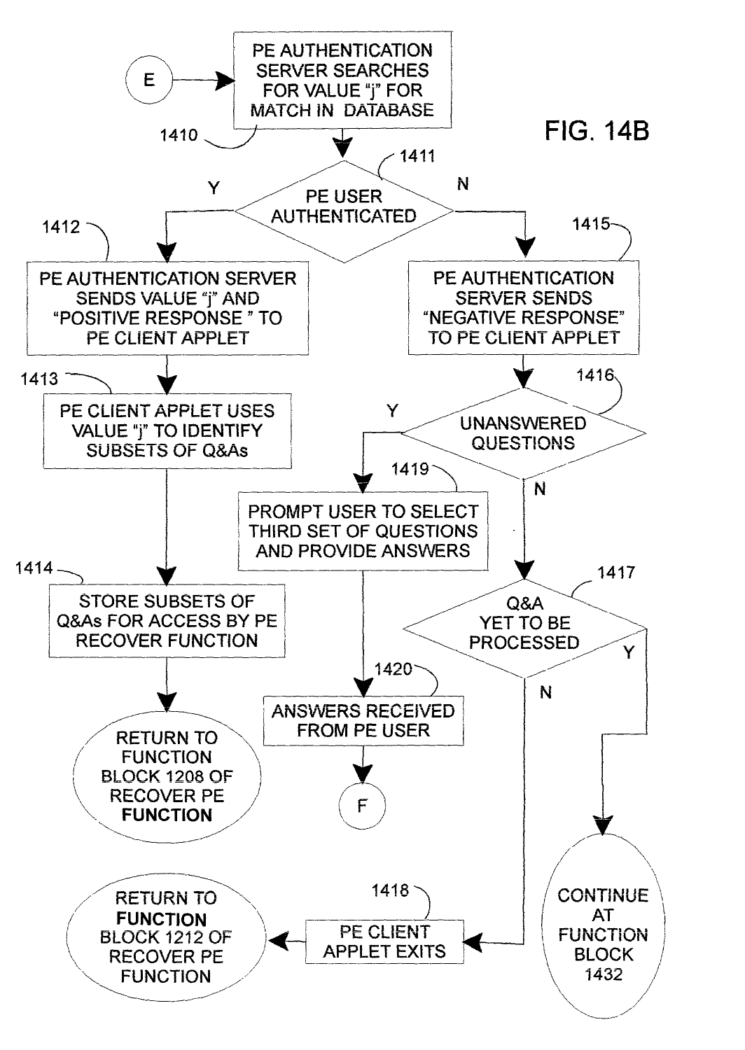

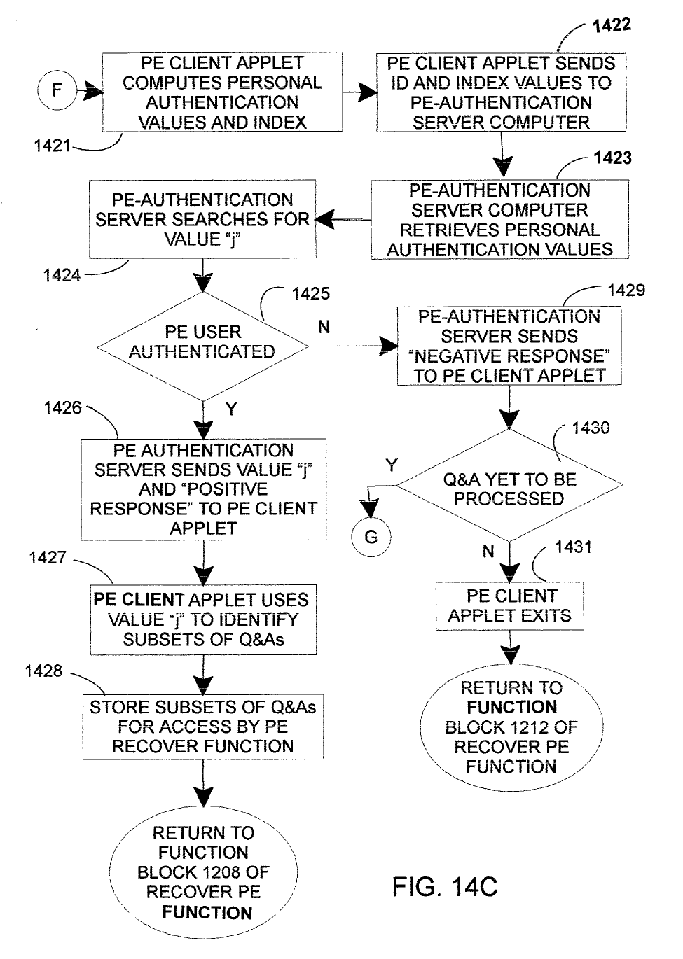

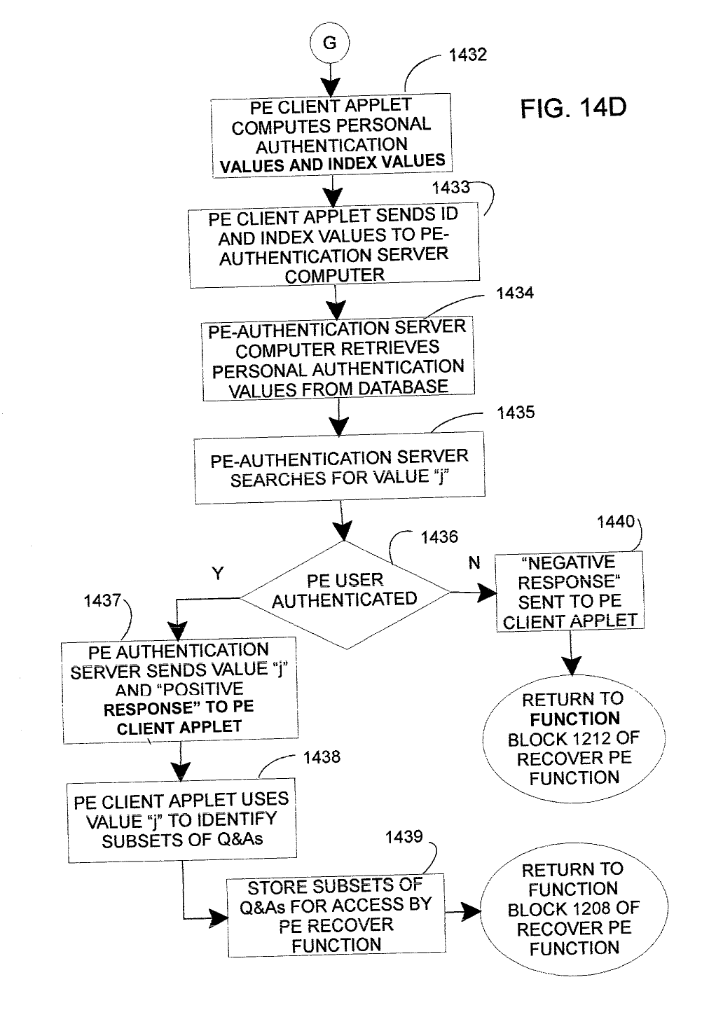

The PE client applet computes cryptographic key Kⱼ in function block 1208 using the j-th subset of questions and the j-th subset of corresponding answers stored by PE client applet so that they will be available to the Recover PE function at step 1314 (FIG. 13B) or 1327 (FIG. 13C) of the first embodiment of the PE answering algorithm or at step 1414 (FIG. 14B), 1428 (FIG. 14C), or 1439 (FIG. 14D) of the second embodiment of the PE answering algorithm. The key, Kⱼ, is computed as follows:

Kⱼ=F₂ (j-th subset of questions identified by the PE answering algorithm, j-th subset of answers identified by the PE answering algorithm, Other information )

Note that in the first embodiment of the PE answering algorithm, the j-th subset of questions identified by the PE answering algorithm contains “m” questions and the j-th subset of corresponding answers identified by the PE answering algorithm contains “m” answers. In the second embodiment of the PE answering algorithm, j-th subset of questions identified by the PE answer algorithm contains either “m” or “m+1” questions and the j-th subset of corresponding answers identified by the PE answering algorithm contains “m” or “m+1” answers, respectively.

Next, in function block 1209 of FIG. 12B, the PE client applet decrypts the encrypted value eK_{1J},(PE_Secret) received from the PE-authentication server computer with the computed key Kⱼ to recover the PE Secret. Next, the PE client applet decrypts the encrypted PE answers, ePE_Secret(A₁), ePE_Secret(A₂), . . . , ePE_Secret(Aₙ), using the recovered value of PE_Secret as the cryptographic key in fuinction block 1210. Next, the PE client applet uses the decrypted PE answers to determine “answers in error”, i.e., incorrect answers provided by the user and the type of error (e.g., key stroke error) in function block 1211. Optionally, the PE client applet may indicate to the PE user the questions that were incorrectly answered and display the correct answers on the display screen. The decision to display the correct answers can also depend on whether the PE user's entered answers are displayed on the display screen or not. If the PE user's entered answers are not displayed on the display screen, then the correct answers for incorrectly answered questions would probably not be displayed as well. Instead, the PE client applet might only indicate to the PE user the questions that were incorrectly answered, but omit displaying the correct answers. On the other hand, if the PE user's entered answers are displayed on the display screen, then the PE client applet might likewise choose to display the correct answers for incorrectly answered questions.

Next, in function block 1212, the PE client applet collects usage data about questions and answers, including questions answered correctly, questions answered incorrectly, questions potentially answered incorrectly, and possibly other information. Other information may include information about the choices made by the PE user (e.g., the questions selected by the PE user to be answered and the data and time of this invocation of the Recover PE function). Next, the PE client updates the system usage data in the PE fields for PE user with personal identifier IDi (or a value mapped from it), namely row “i”, stored in the PE-authentication server computer database in function block 1213 To accomplish this, the PE client applet should establish a communication path with the PE-authentication server computer (preferably via the mediation of the PE Controller to allow for centralized session management), which is outside the scope of the present invention, although well understood in the present state-of-the-art. The communication path is preferably an encrypted path, i.e., the PE client applet and the PE-authentication server computer (or the PE-controller server computer on behalf of the PE-authentication server computer) could establish a common key to encrypt and protect all communications between them. The PE client applet sends the PE user's personal identifier together with the PE user's PE values (namely the system usage data) to the PE-authentication server computer (or to the PE-Controller server computer which optionally maps the personal identifier to another value and passes the information to the PE-authentication server computer). In turn, the PE-authentication server computer stores the PE values in a PE row “i” in the database of the PE-authentication server computer indexed by the PE-user's personal identifier IDₗ (or mapped value). Finally, any unneeded secret values are overwritten and then erased in function block 1214 The PE user exits the Recover PE function and, if necessary, the PE client applet passes the recovered PE Secret to a using application.

An important aim of the PE answering algorithm is to minimize the time and effort required of users to recover their PE secrets. One of the potential problems associated with a PE system is that the user must enter or key-in several answers, and the greater the number of answers keyed-in, the greater the probability that the user will make a keystroke error. Therefore, keystroke errors or entry errors, which are made during the process of keying-in PE answers, can pose a particularly serious problem for a PE system. The simple and straightforward way to address the problem, though it does not completely eliminate the problem, would be to display the entered answers to the user. This visual feedback would allow many keystroke and entry errors to be visually detected and corrected, by users, before being processed. However, displaying answers presents an obvious potential security risk, since others, including potential adversaries, may see displayed answers as well. In attempting to balance these two concerns, two observations can be made. First, some users may have difficulty “blindly” entering PE answers, whereas others may have no difficulty, and second, there are probably times when displaying entered answers would present a security risk, but there are probably also times when displaying entered answers would present no security risk. Therefore, a method for overcoming the potential problem of displaying answers, suggested by the above observations, would be for the PE system to provide an option allowing users to specify whether entered answers are to be displayed, or not. The default mode could be “Hide Answers”, in which case the user would have to override the mode setting in order to have his/her answers displayed. A “Show Answers” button in the User Interface (UI) could serve this purpose. If the “Show Answers” button is clicked prior to entering answers, then the system will display the entered answers and the button automatically changes to “Hide Answers.” The “Show Answers” button has no effect if clicked after answers are entered. However, the user can disable the display of entered answers at any time by clicking the “Hide Answers” button, and once disabled the display of answers cannot be enabled until after all answers have been entered and the buffer cleared, or unless the user elects to start over.

The present invention addresses PE system implementations in which the PE system is configured to always “Show Answers” or to always “Hide Answers”, as well as implementations in which users have the option to dynamically select either “Show Answers” or “Hide Answers.”

Another aim of the present invention is to minimize problems associated with multi-word answers with no implied order. As stated previously, it is possible for a user to create a Q&A such that the words comprising the answer have no implied order. If the PE system requires the user to demonstrate the correct order of these words, then the PE secret will not be generated if the correct words are entered in the wrong order. For example, consider the question “Who where two boyhood friends?” Suppose the answer is “Flick” and “Schwartz”. However, there is no easy way to determine the correct order. Is the answer “Flick” and “Schwartz” or “Schwartz” and “Flick?”

One remedy would be to instruct users to avoid the potential problem by creating Q&A where the words in the answer have an implied order. But, such a rule could unnecessarily eliminate useful Q&As. Another solution, where there is no implied word order, would be to instruct users to arrange the words in ascending alphabetical sequence, thus imposing a superficial ordering on the words. Another possibility would be for the PE system itself to enforce a canonical ordering on the words in each answer. However, imposing a canonical ordering on words in each answer would reduce the overall entropy of the answers, and in any case the solution would be “overkill” in situations where there already existed a natural ordering of the words in the answer. Another, perhaps, better solution would be for the system to offer an option allowing users to specify whether the words in an answer have or do not have a natural word ordering. In that case, when the user specifies to the system that the words have no natural word ordering, the system would impose a canonical ordering on the words, e.g., by arranging the words in ascending sorted sequence. The loss in entropy in the answers would not be so serious if only one or two of the answers used an enforced canonical ordering on the words in an answer.

First Embodiment

The first embodiment of the PE answering algorithm has two iterations of PE user authentication, based on “n” previously created Q&As. At the first iteration, the PE user selects and answers “k” PE questions, where 0<m ≦k≦n and “m” is a predetermined constant. That is, the user must answer at least “m” questions, but can elect to answer up to “n” questions. The set of “k” questions consists of a first subset of “m” questions and an optional second subset of “k₁” questions (k₁=k−m). If the PE user fails to be authenticated at the first iteration and there are remaining unanswered questions (n-k>0), then the PE user is given an opportunity to answer an additional third subset of “k₂” questions from the remaining n-k unanswered questions (k₂≦n-k). The PE user is authenticated on the basis of “m” Q&As, where these “m” Q&As are selected in a predetermined way by the PE answering algorithm from among the Q&As specified by the PE user. In particular, there are up to m×(k₁+k₂)+1 different possible combinations of “m” Q&As that are or that can be used to authenticate the PE user. They are:

The “m” Q&A associated with the first subset ofr“m” questions selected by the PE user, and

The “m” different subsets of “m-1” Q&A drawn from the first subset of “m” questions selected by the PE user and combined with the (k₁+k₂) different single Q&A drawn from the union of the second subset of “k1” questions and the third subset of “k₂” questions selected by the PE user.

FIGS. 13A, 13B, and 13C, taken together, are a flowchart of the processing steps performed by the PE Answering Algorithm in accordance with the first embodiment of the present invention. Referring first to FIG. 13A, the UI displays “n” questions and system usage data in function block 1301. The UI may also flag the “m” questions statistically indicated as those most easily answered by the user. The “n” questions are just those that the PE user created in a prior invocation of the Create PE function. The system usage data is collected by the PE client applet during prior invocations of the Recover PE function. System usage data is also collected during the present invocation of the Recover PE function, and in turn is combined with prior collected system usage data. The updated system usage data, or portion therefore, or function thereof, is displayed to the PE user at the next invocation of the Recover PE function. In particular, the PE client applet keeps track of the number of times each question is correctly answered, incorrectly answered (if that information can be determined), and the number of times questions are attempted to be answered as part of a group of “m” questions, where at least one of the questions is answered incorrectly. The PE client applet can also keep track of the number of times the Recover PE function is invoked, as well as the date and time when it was last invoked.

The PE user makes use of the displayed system usage data, or portion thereof, or function thereof, to select a first set of “m” questions to be answered (m<n), where “m” is a predetermined constant. The PE user then provides answers to the selected “m” questions in function block 1302. In this step, the PE answering algorithm (via the UI) requires the user to select and answer “m” of the “n” displayed questions.

Next, in function block 1303, the UI gives the PE user the option to select a second set of “k₁” additional unanswered questions (k₁≦n-m), where “k₁” is a variable value determined by the PE user. A determination is made in decision block 1304 as to whether the PE user chooses to answer additional questions. If the PE user chooses not to answer additional questions, then control passes to the next step in function block 1306. Otherwise, the PE user selects “k₁” additional unanswered questions and provides answers to the selected “k₁” questions in function block 1305. As before, the PE user can make use of the displayed system usage data, or portion thereof, or function thereof, to select the “k₁” additional questions. The value “k₁” can change from PE session to PE session and from PE user to PE user. In this case, the PE answering algorithm (via the UI) permits the PE user to select up to “n-m” additional questions and provide answers, but does not require the PE user to answer additional questions—answering additional questions is strictly optional.

The PE user clicks on a “submit” button displayed to the PE user by the UI on the display screen in function block 1306. This indicates to the PE client applet that the PE user is finished providing answers to selected questions. At any time prior to clicking on the “submit” button, the PE user is permitted to change answers to any of the previously selected “m+k₁” questions. In function block 1307, the PE client applet computes the personal authentication values PAV_{index}_{₁}, PAV_{index}_{₂}, . . . , PAVE_{index}_{ₖ} from the k=(m×k₁)+1 combinations of “m+k₁” Q&As provided by the PE user. The PE client applet also computes the index values index₁, index₂, . . . , indexₖ in function block 1307. The j-th personal authentication value, PAV_{index}_{ⱼ}, is computed, as described above, using the formula:

PAV_{index}_{ⱼ}=F₁(j-th subset of“m” questions drawn from set {Q₁, Q₂, Qₘ₊ₖ_{₁}}, j-th subset of “m” answers drawn from set {A₁, A₂, . . . , Aₘ₊ₖ_{₁}}, Other Information)

The k=(m×k₁)+1 combinations of “m+k₁” Q&As are determined as follows. One personal authentication value is computed using the “m” Q&As specified at function block 1302. (m×k₁) personal authentication values are computed using each combination of “m-1” Q&As specified in function block 1302 (resulting in “m” combinations) together with each combination of one Q&A specified in function block 1303 (resulting in k₁ combinations).

For example, if m=5 and k₁=2, then there are 5×2=10 ways to combine four Q&As drawn from the first set of five Q&As (five combinations) with one Q&A drawn from the second set of two Q&As (two combinations). And, there is one way to select five Q&As from the first set of five Q&As. In this case, there are K=10+1=11 different personal authentication values computed from the eleven combinations of 5 Q&As.

The values index₁, index₂, . . . , indexₖ represent k different values where each value is an element in the set {1, 2, . . . , t}. The values of index₁, index₂, . . . , indexₖ are computed using a table lookup method, which can be described by a simple “toy” example. For example, consider values n=5 and m=3, in which case t=5C3=5!/(3!2!)=10, i.e., there are ten combinations of five Q&As taken three at a time. Suppose that each of the five Q&As is numbered 1 through 5, namely Q&A₁, Q&A₂, Q&A₃, Q&A₄, and Q&A₅, i.e., each Q&A has a canonical number assigned to it, namely 1, 2, 3, 4, and 5. We now construct a five dimensional array A(n₁, n₂, n₃, n₄, n₅), where each index n₁, n₂, n_{3,} n₄, and n₅ has values 0 (“no”) or 1 (“yes”), and each index n₁, n₂, n₃, n₄, and n₅ corresponds to one of the five Q&As arranged in canonical order, Q&A₁, Q&A₂, Q&A₃, Q&A₄ and Q&A₅, respectively. Array “A” is initialized with the t different index values, 1, 2, . . . , 10, show below:

A(0,0,0,0,0): 0 A(0,1,0,0,0): 0 A(1,0,0,0,0): 0 A(1,1,0,0,0): 0

A(0,0,0,0,1): 0 A(0,1,0,0,1): 0 A(1,0,0,0,1): 0 A(1,1,0,0,1): 8

A(0,0,0,1,0): 0 A(0,1,0,1,0): 0 A(1,0,0,1,0): 0 A(1,1,0,1,0): 9

A(0,0,0,1,1): 0 A(0,1,0,1,1): 2 A(1,0,0,1,1): 5 A(1,1,0,1,1): 0

A(0,0,1,0,0): 0 A(0,1,1,0,0): 0 A(1,0,1,0,0): 0 A(1,1,1,0,0): 10

A(0,0,1,0,1): 0 A(0,1,1,0,1): 3 A(1,0,1,0,1): 6 A(1,1,1,0,1): 0

A(0,0,1,1,0): 0 A(0,1,1,1,0): 4 A(1,0,1,1,0): 7 A(1,1,1,1,0): 0

A(0,0,1,1,1): 1 A(0,1,1,1,1): 0 A(1,0,1,1,1): 0 A(1,1,1,1,1): 0

The reader will observe that the elements in array “A” are non-zero whenever there are exactly three index values equal to “1” and in all other cases the elements in array “A” are zero. Furthermore, the reader will observer that there are exactly ten different elements in array “A” that have exactly three index values equal to “1” and that these ten different elements contain the values 1, 2, . . . , 10, respectively. The array “A” is easily initialized via a nested “For Loop” in which an incrementing counter, whose initial value is one, is assigned to the array element if the sum of the index values is three, and is assigned zero otherwise. Array “A” can be used to compute PAV index values as follows. Suppose that we have a first subset of three Q&As consisting of Q&A₂, Q&A₃, and Q&A₅. In that case, n₁=0, n₂=I, n₃=1, n₄=0, and n₅=1, and array element A(0,1,1,0 1)=3. Therefore, index₁=3. If we have a second subset of three Q&As consisting of Q&A₂, Q&A₄, and Q&A5, then n₁=0, n₂=1, n₃=0, n₄=1, n₅=1, A(0,1,0,1,1)=2, and so index_{2=2.} If there are k different subsets, and hence k different index values, then each index value is computed in a similar manner. If we had values n=9 and m=5, then we would construct a 9-dimensional array with nine index values of 0 or 1, and the array would be initialized with t=9C5=9!/(5!4!)=126 different index values 1, 2, . . . , 126.

The PE client sends ID₁ and (index₁, PAV_{index}_{₁}), (index₂, PAV_{index}_{₂}) . . . , (indexₖ, PAV_{index}_{ₖ}) to the PE-authentication server computer and requests the PE-authentication server computer to authenticate the PE user in function block 1308. The PE-authentication server computer uses the received ID₁ to retrieve the personal authentication values PAV_{l,1}, PAV_{l,2}, . . . , PAV_{l,t} stored in row “i” of its database in function block 1309.

Referring now to FIG. 13B, the PE-authentication server computer searches in function block 1310 for a value “j” such that the value PAV_{J} for some (J, PAV_{J}) in the list (index₁, PAV_{index}_{₁}), (index₂, PAV_{index}_{₂}) , . . . , (indexₖ PAV_{index}_{ₖ}) received from the PE client applet is equal to the value PAV_{lJ} in the list PAV_{l,1}, PAV_{l,2}, . . . , PAVₗₜ retrieved from the PE-authentication server computer database. A determination is made in decision block 1311 as to whether such a value is found. If found, then the PE user with identifier ID₁ is authenticated; otherwise, the PE user is not authenticated. If the PE user is authenticated, the PE-authentication server computer sends a “positive response” to the PE client applet in function block 1312. Along with this “positive response” is sent the following additional information: (1) the index value “J”, (2) the j-th encrypted PE secret value eK_{lJ}(PE_Secret) for the PE user with identifier IDₗ retrieved from the PE-authentication server computer database, and (3) the encrypted PE answers ePE_Secret(A₁), ePE_Secret(A₂), . . . , ePE_Secret(A,) for PE user with identifier IDₗ retrieved from the PE-authentication server computer database. If the PE user is not authenticated, the PE-authentication server computer sends a “negative response” to the PE client applet in function block 1315. If the PE user is successfully authenticated, then the PE client applet uses index value “J” received from the PE-authentication server computer to identify the j-th subset of questions and the j-th subset of answers used to compute PAV_{J} in function bock 1313, and this information is saved in function block 1314 so that it will be available to the Recover PE function. The PE client applet then exits the PE answering algorithm and control passes to function block 1208 (FIG. 12A) of the Recover PE function. If the PE user is not successfully authenticated, a determination is made in decision block 1316 as to whether there are unanswered questions remaining in the original set of n questions. If there are no unanswered questions (n-m- K₁=0), then the PE client applet exits the PE answering algorithm at function block 1317, and control passes to function block 1212 (FIG. 12B) of the Recover PE function. If the PE user is not successfully authenticated and there are unanswered questions (n−m−k₁>0), then control passes to function block 1318 of the PE answering algorithm.

One method for determining the j-th subsets of questions and answers using index “j” would be to search the elements of array “A” until an element is found equal to “j”. The index values {I₁, I₂, . . . , Iₙ} of array “A” would then determine the j-th subsets of questions and answers. For example, if n=9, m=5 and I₁,=1, I₂=0, I₃=0, I₄=1, I₅=1, I₆=0, I₇=1, I₈=1, I₉=0, and user authentication is based on say, five, Q&As, then the j-th subsets of questions and answers would consist of {Q₁, Q₄, Q₅, Q₇, Q₈} and {A₁, A₄, A₅, A₇, A₈}, respectively, where we assume that the “n” questions and answers can be arranged in a canonical order and the indices refer to the canonical positions of the respective elements. Note that the intent here is to only show that a method does exist to map the index value “j” back to the j-th subsets of questions and answers; the illustrated method is not a “best” method.

The PE user selects a third set of “k₂” of the “n−m−k₁” additional unanswered questions (0<k₂≦n−m−k₁), where “k₂” is a variable value determined by the PE user. The PE user then provides answers to the selected “k₂” questions in function block 1318. As before, the PE user can make use of the displayed system usage data, or portion thereof, or function thereof, to select the “k₂” additional questions. The value “k₂” can change from PE session to PE session and from PE user to PE user. In this case, the PE answering algorithm (via the UI) permits the PE user to select up to “n−m−k₁” additional questions and provide answers, but does not require the PE user to answer additional questions—answering additional questions is strictly optional.

The PE user clicks on a “submit” button displayed to the PE user by the UI on the display screen in function block 1319. This indicates to the PE client applet that the PE user is finished providing answers to selected questions. At any time prior to clicking on the “submit” button, the PE user is permitted to change answers to any of the previously selected “m+k₁+k₂” questions.

Referring next to FIG. 13C, the PE client applet computes the personal authentication values PAV_{index}_{₁}, . . . , PAV_{index}_{₂}, . . . , PAV_{index}_{ₖ} from the K=(m×k₂) combinations of “m+k₂” Q&As provided by the PE user in function block 1320. The PE client applet also computes the index values index₁, index₂, . . . , indexₖ. The j-th personal authentication value, PAV_{index}j, is computed, as described above, using the formula:

PAV_{index}_{ⱼ}=F₁ (j-th subset of “m” questions drawn from set {Q₁, Q₂, Qₘ₊ₖ}, j-th subset of “m” answers drawn from set {A₁, A₂, . . . , Aₘ₊ₖ_{ₖ}}, Other Information)

The k personal authentication values (K=m×k₂) are computed from the k combinations of “m” Q&As as follows: Each of the of “m-1” Q&As drawn from the first set of “m” Q&As specified in function block 1302 (FIG. 13A) (resulting in “m” combinations) is combined with one Q&A drawn from the third set of “k₂” Q&As specified in function block 1318 (FIG. 13B) (resulting in k₂ combinations). For example, if m=5 and k₂=2, then there are 5×2=10 ways to combine four Q&As drawn from the first set of five Q&As (five combinations) with one Q&A drawn from the second set of two Q&As (two combinations). The PE client applet sends ID, and (index₁, PAV_{index}_{₁}), (index₂, PAVindex_{₂}), . . . , (indexₖ, PAV_{index}_{ₖ}) to the PE-authentication server computer and requests the PE-authentication server computer to authenticate the PE user in function block 1321. The PE-authentication server computer uses the received ID, to retrieve the personal authentication values PAV_{l,1}, PAV_{l,2}, . . . , PAV_{l,t} stored in row “i” of its database in function block 1322.

The PE-authentication server computer searches for a value “j” such that the value PAVⱼ for some (j, PAVⱼ) in the list (index₁, PAV_{index}_{₁}), (index₂, PAV_{index}_{₂}), . . . , (indexₖ, PAV_{index}_{ₖ}) received from the PE client applet is equal to value PAVₗⱼ in the list PAV_{l,1}, PAV_{l,2}, . . . , PAV_{l,1} retrieved from the PE-authentication server computer database in function block 1323. A determination is made in decision block 1324 as to whether such a value is found and, if so, then the PE user with identifier ID, is authenticated; otherwise, the PE user is not authenticated. If the PE user is authenticated, the PE-authentication server computer sends a “positive response” to the PE client applet in function block 1325, along with (1) the index value “j”, (2) the j-th encrypted PE secret value eKₗⱼ (PE_Secret) for PE user IDₗ retrieved from the PE-authentication server computer database, and (3) the encrypted PE answers ePE_Secret(Al), ePE_Secret(A₂), . . . , ePE_Secret(Aₙ) for PE user IDₗ retrieved from the PE-authentication server computer database. If the PE user is not authenticated, the PE-authentication server computer sends a “negative response” to the PE client applet in function block 1328. If the PE user is successfully authenticated, then the PE client applet uses index value “j” received from the PE-authentication server computer to identify the j-th subset of questions and the j-th subset of answers used to compute PAV_{J} in function block 1326, and this information is saved in function block 1327 so that it will be available to the Recover PE function. The PE client applet then exits the PE answering algorithm and control passes to function block 1208 (FIG. 12A) of the Recover PE function. If the PE user is not successfully authenticated, then the PE client applet exits the PE answering algorithm and control passes to function block 1212 (FIG. 12B) of the Recover PE function.

One method for determining the j-th subsets of questions and answers using index “j” would be to search the elements of array “A” until an element is found equal to “j”. The index values {I₁, I₂, . . . , Iₙ} of array “A” would then determine the j-th subsets of questions and answers. For example, if n=9, m=5and I₁=, 1, I₂=0, I₃=0, I₄=1, I₅=1, I₆=0, I₇=1, I₈=1, I₉=0, and user authentication is based on say, five, Q&As, then the j-th subsets of questions and answers would consist of {Q₁, Q₄, Q₅, Q₇, Q₈} and {A₁, A₄, A₅, A_{7,} A₈}, respectively, where we assume that the “n” questions and answers can be arranged in a canonical order and the indices refer to the canonical positions of the respective elements. Note that the intent here is to only show that a method does exist to map the index value “j” back to the j-th subsets of questions and answers; the illustrated method is not a “best” method.

In a first variation of the first embodiment of the PE answering algorithm, the PE user is allowed to answer only “m” questions at the first iteration of the PE answering algorithm. That is, the variable k₁ is forced to be zero “0.” In this case, the user selects and answers “m” questions at the first iteration of the PE answering algorithm and selects and answers from 1 to “n-m” questions at the second iteration of the PE answering algorithm.

In a second variation of the first embodiment of the PE answering algorithm, the PE user is allowed to repeat the final step of selecting and answering k₂ questions until one of the following conditions is met: (1) the PE user is successfully authenticated, (2) the PE user chooses to discontinue, or (3) the PE user fails to be authenticated after answering all n questions. In a third variation of the first embodiment of the PE answering algorithm, the system can make k₁ or k₂ or both predetermined constants, in which case k₁ and k₂ are fixed values rather than variable values determined by each PE user.

In a preferred implementation of the first embodiment of the PE answering algorithm, n=9, m=5, and k₁=0 are predetermined constants determined by the PE answering algorithm and k₂=1, 2, 3, or 4 is a variable value determined by the PE user, which can change from PE session to PE session and PE user to PE user. At the first iteration, the PE user must select and answer five of the nine questions. The PE system attempts to authenticate the PE user on the basis of the specified five Q&As. If unsuccessful, then a second iteration is performed in which the PE user must select and answer from one to four of the remaining four unanswered PE questions. The PE system again attempts to authenticate the PE user, except in this case only (5×k₂) of the total (5+k₂)C5=(5+k₂)!/5!k₂! combinations of five Q&As are selected and used for authentication. For example, if k₂=1, then (5×1)=5 and (5+1)C5=6; if k₂=2, then (5×2)=10 and (5+2)C5=21; if k₂=3, then (5×3)=15 and (5+3)C5=56; if k₂=4, then (5×4)=20 and (5+4)C5=126. In particular, the subsets of five Q&As used to authenticate the PE user are obtained by combining each possible combination of four Q&As selected from the five Q&As specified at the first iteration with each possible combination of one Q&A selected from the k₂=1, 2, 3, or 4 Q&As specified at the second iteration.

The rationale for this procedure can be explained. In general, a PE user's ability and success rate in answering PE questions will not be the same for each of the nine Q&As. If an experiment were performed to measure the PE user's ability to answer each PE question, and statistics were accumulated for many users, one would find that each user's PE questions could be ranked according to the user's success rate in answering each PE question. Moreover, the PE users themselves would most likely be able to predict the PE questions they are most apt to be able to answer correctly and those that they may “stumble” on, or have difficulty with. Also, some PE users may experience “memory blocks” and the PE questions affected by “memory blocks” can vary from one PE session to another. But, since the PE user is the one who selects five of the nine PE questions to be answered, the user will have no difficulty in avoiding PE questions that s/he may experience a “memory block” on. In effect, the process of selecting five of the nine PE questions can be thought of as a process in which the nine PE questions are divided into two sets of five and four questions, respectively. For convenience, let us call the set of five questions and associated answers set “A” and the set of four questions and associated answers set “B”. In general, we could say the following about the Q&As in sets “A” and “B.” Set “A” contains questions that we feel most confident have been answered correctly and, by inference, set “B” contains questions that we feel least confident have been answered correctly. If the PE user fails to be authenticated at the first iteration, i.e., where authentication is based on the five questions selected and answered at the first iteration, then the PE answering algorithm proceeds to the second iteration, which has the following objectives:

Authenticate the PE User

The ultimate goal of the PE system is to authenticate the user. Therefore, the PE system should be designed to maximize the likelihood that PE users are successfully authenticated.

Minimize the Time and Effort of the PE User

The PE system should be designed such that PE users can be authenticated in the least time and with the least effort expended by the PE user.

Therefore, since the PE user has already expended time in effort interacting with the PE system at the first iteration, it makes sense to allow the PE user to expend a some additional time and effort at a second iteration, if this leads to at least a comparable increased likelihood that the PE user will be successfully authenticated.

Avoid “Guessing Attacks”

The PE system cannot eliminate the threat of “guessing attacks.” However, the PE system should minimize the threat of “guessing attacks” by limiting the number of guesses an attacker can make in a single PE session. At the second iteration, the PE user can answer one, two, three, or four PE questions. The choice of the number of questions selected at the second iteration is a choice made by the PE user. In this case, the PE user must balance the likelihood of being successfully authenticated against the additional time and effort required in selecting and answering these additional PE questions. For example, one PE user may feel confident s/he will be authenticated by answering only two additional PE questions, whereas another PE user may feel confident only by answering four additional PE questions. In a second variation of the first embodiment of the PE answering algorithm, the PE user is allowed to repeat the second iteration of selecting and answering k₂ questions until all n questions have been answered. In this case, if the PE user answered two additional questions but failed to be authenticated, he or she could still answer the remaining two questions with the hope that this would lead to a successful authentication.

In arriving at a good strategy for authenticating the PE user, one will observe that there are 9C5=9!/5!(9-5)!=126 different combinations of five Q&As that can be formed from the nine Q&As created by the PE user. In theory, if the PE user were to answer all nine PE questions, there would be 126 possible combinations of five Q&As that could be formed from the nine Q&As and used as a basis for authenticating the PE user. But, it would also give the attacker 126 trials to guess five correct answers at each PE session. Fortunately, there is a better tradeoff that can be made. One can see that out of the 126 possible combinations of five PE questions, some combinations of five questions are more likely to be answered correctly by the PE user then others. Hence, a good PE answering algorithm should not make use of all 126 combinations of five PE questions, since the advantage given up to the attacker is disproportional to the advantage gained by the PE user (in favor of the attacker)- A better strategy would be to make more effective use of the five questions, and associated answers, specified by the PE user at the first iteration, since these are the ones most likely to be answered correctly. A more optimal algorithm would be this: allow only some additional combinations of five Q&As to be used for authentication, and “load” these additional combinations with Q&As taken from the initial five Q&As specified at the first iteration. In this case, we take different combinations of four Q&As from the five Q&As specified at the first iteration and combine them with one Q&A from the one, two, three, or four Q&As specified at the second iteration, thus giving five “weighted” Q&As, i.e., weighted with four Q&As from the first iteration, which we feel most confident about, and one Q&A from the second iteration, which we feel least confident about. Altogether, this gives twenty additional combinations of five Q&As that can be used to authenticate the PE user at the second iteration. On the one hand, this strategy reduces the number of trials from 126 to 20, thus greatly reducing the number of trials per session that an attacker can use in a “guessing attack.” On the other hand, the twenty additional trials or combinations of Q&As provide a significant increased chance for the PE user to be authenticated, since they are “weighted” with Q&As that are most likely to be answered correctly.

Second Embodiment

The second embodiment of the PE answering algorithm has three iterations of PE user authentication, based on “n” previously created Q&As. At the first iteration, the PE user selects and answers “k” PE questions, where 0<m≦k≦n and “m” is a predetermined constant. That is, the user must answer at least “m” questions, but can elect to answer up to “n” questions. The set of “k” questions consists of a first subset of “m” questions and an optional second subset of “k₁” questions. If the PE user fails to be authenticated at the first iteration and there are remaining unanswered questions (n-k>0), then the PE user is given an opportunity to answer an additional “k₂” questions (constituting a third subset of “k₂” questions), of the remaining n-k unanswered questions (k₂≦n−m−k₁). The PE user is authenticated on the basis of “m” Q&As, where these “m” Q&As are selected in a predetermined way by the PE answering algorithm, from among the Q&As specified by the PE user. In particular, there are up to m×(k₁+k₂)+1 different possible combinations of “m” Q&As that are, or can be, used to authenticate the PE user. They are:

The “m” Q&A associated with the first subset of“m” questions selected by the PE user, and

The “m” different subsets of “m-1” Q&A drawn from the first subset of“m” questions selected by the PE user and combined with the (k₁+k₂) different single Q&A drawn from the union of the second subset of “k₁” questions and the third subset of “k₂” questions selected by the PE user.

If the PE user fails to be authenticated at the second iteration and there are sufficient Q&As available for further processing (k₁+k₂≧3), then the PE answering algorithm will further attempt to authenticate the user on the basis of “m+1” Q&As, where these “m+1” Q&As are selected in a predetermined way by the PE answering algorithm, from among the Q&As specified by the PE user. In particular, there are up to mC(m-2)×(k₁+k₂)C3=m!/((m-2)!2! ×(k₁+k₂)!/3!(k₁+k₂-3)! different possible combinations of“m+1” Q&As that are, or can be, used to authenticate the PE user. They are: Each combination of “m-2” Q&As drawn from the initial set of “m” Q&As specified at the first iteration is combined with each combination of 3 Q&As drawn from the union of the sets of “k₁” and “k₂” Q&As specified at the first and second iterations.

FIGS. 14A, 14B, 14C, and 14D, taken together, are a flowchart of the processing steps performed by the PE Answering Algorithm in accordance with the second embodiment of the present invention. First, the UI displays “n” questions and system usage data in function block 1401. The UI may also flag the “m” questions statistically indicated as those most easily answered by the user. The “n” questions are just those that the PE user created in a prior invocation of the Create PE function. The system usage data is collected by the PE client applet during prior invocations of the Recover PE function. System usage data is also collected during the present invocation of the Recover PE function, and in turn is combined with prior collected system usage data. The updated system usage data, or portion therefore, or function thereof, is displayed to the PE user at the next invocation of the Recover PE function. In particular, the PE client applet keeps track of the number of times each question is correctly answered, incorrectly answered (if that information can be determined), and the number of times questions are attempted to be answered as part of a group of “m” questions, where at least one of the questions is answered incorrectly. The PE client applet can also keep track of the number of times the Recover PE function is invoked, as well as the date and time when it was last invoked.

The PE user makes use of the displayed system usage data, or portion thereof, or function thereof, to select a first set of “m” questions to be answered (m<n), where “m” is a predetermined constant. The PE user then provides answers to the selected “m” questions in function block 1402. In this step, the PE answering algorithm (via the UI) requires the user to select and answer “m” of the “n” displayed questions.

Next, in function block 1403, the UI gives the PE user the option to select a second set of “k₁” additional unanswered questions (k₁≦n-m), where “k₁” is a variable value determined by the PE user. A determination is made in decision block 1404 as to whether the PE chooses to answer additional questions. If the PE user chooses not to answer additional questions, then control passes to the next step in function block 1406. Otherwise, the PE user selects “k₁” additional unanswered questions and provides answers to the selected “k₁” questions in function block 1405. As before, the PE user can make use of the displayed system usage data, or portion thereof, or function thereof, to select the “k₁” additional questions. The value “k₁” can change from PE session to PE session and from PE user to PE user. In this case, the PE answering algorithm (via the UI) permits the PE user to select up to “n-m” additional questions and provide answers, but does not require the PE user to answer additional questions—answering additional questions is strictly optional.

The PE user clicks on a “submit” button displayed to the PE user by the UI on the display screen in function block 1406. This indicates to the PE client applet that the PE user is finished providing answers to selected questions. At any time prior to clicking on the “submit” button, the PE user is permitted to change answers to any of the previously selected “m” or “m+k₁” questions. In function block 1407, the PE client applet computes the personal authentication values PAV_{index}_{₁}, PAV_{index}_{₂}, . . . , PAV_{index}_{ₖ} from the k=(m×k₁)+1 combinations of “m” Q&As drawn from the set of “m+k₁” Q&As provided by the PE user. The PE client applet also computes the index values index₁, index₂, . . . , indexₖ in function block 1407. The j-th personal authentication value, PAV_{index}_{ⱼ}, is computed, as described above, using the formula:

PAV_{index}_{ⱼ}=F₁(j-th subset of“m” questions drawn from set {Q₁, Q₂, Q+k_{₁}}, j-th subset of “m” answers drawn from set {A₁, A₂, . . . , Aₘ₊ₖ_{₁}}, Other Information)

The k=(m×k₁)+1 combinations of“m” Q&As used to compute personal authentication values is determined as follows: One personal authentication value is computed using the “m” Q&As specified in function block 1402. (m×k₁) personal authentication values are computed as follows: Each combination of “m-1” Q&As drawn from the first set of “m” Q&As specified in function block 1402 (resulting in “m” combinations) is combined with each combination of one Q&A drawn from the second set of “k₁” Q&As specified in function block 1405 (resulting in k₁ combinations). However, if the PE user elected not to answer additional questions in decision block 1404, then the second set of Q&A is empty, in which case k₁=0 and K=1, and so there is only one personal authentication value computed (k=1). For example, if m=5 and k₁=2, then there are 5×2=10 ways to combine four Q&As drawn from the first set of five Q&As (five combinations) with one Q&A drawn from the second set of two Q&As (two combinations). And, there is one way to select five Q&As from the first set of five Q&As, and so there are k=10+1=11 different personal authentication values computed from the eleven combinations of five Q&As.

The values of index (index₁, index₂, . . . , indexₖ) are computed using an n-dimensional array “A,” as follows:

index=A(I₁, I₂, . . . , Iₙ) where,

Iₚ=1, if the p-th Q&A is present

Iₚ=0, if the p-th Q&A is not present and the elements of array “A” range in value from 0 to t₁, where t₁=nCm=n!/m!(n-m)!. index₁ would be computed using the first subset of“m” Q&As, index₂ would be computed using the second subset of“m” Q&As, and so forth, and indexₖ would be computed using the k-th subset of“m” Q&As. Array “A” is initialized as follows: (1) if I₁+I₂+ . . . +Iₙ=m, then A(I₁, I₂, . . . , Iₙ) is assigned a value from 1 to t, where each value from 1 to t occurs only once in array “A”, and (2) if I₁+I₂+ . . . +Iₙ≠m, then A(I₁, I₂, . . . , Iₙ) is assigned value zero “0.” We assume that the “n” Q&As have a canonical order such that, given any one of the “n” Q&A, its rank or position within the ordered list of Q&As can easily be determined. For example, the Q&A could be ordered according to the sorted order of the questions, which are arranged in ascending sequence. The first Q&A is associated with index I1, the second Q&A is associate with index I₁, and so forth. Hence, given any subset of “m” Q&As drawn from the set of “n” Q&As, one can easily compute its index by determining the rank or position of each Q&A in the canonical list of Q&As, determining the values of I₁, I₂,. . . , Iₙ, and then accessing element A(I₁, I₂, . . . , Iₙ) in matrix “A.”

The method of computing index values can be illustrated with a “toy” example in which n=5 and m=3. In this case, t=5C3=5!/(3!2!)=10, i.e., there are ten combinations of five Q&As taken three at a time. Suppose that each of the five Q&As is numbered one through five, namely Q&A₁, Q&A₂, Q&A₃, Q&A₄, and Q&A₅. That is, each Q&A has a canonical number assigned to it, namely 1, 2, 3, 4, and 5. We now construct a five-dimensional array A(n₁, n₂, n₃, n₄, n₅) where each index n₁, n₂, n₃, n₄, and n₅ can have the value 0 (“no”) or the value 1 (“yes”), and each index n₁, n₂, n₃, n₄, and n₅ corresponds to one of the five Q&As arranged in canonical order, Q&A₁, Q&A₂, Q&A₃, Q&A₄ and Q&A₅, respectively. Array “A” is initialized with the t different index values, 1, 2, . . . , 10, as shown below:

| | | | |
|---|---|---|---|
| A(0,0,0,0,0): 0 | A(0,1,0,0,0): 0 | A(1,0,0,0,0): 0 | A(1,1,0,0,0): 0 |
| A(0,0,0,0,1): 0 | A(0,1,0,0,1): 0 | A(1,0,0,0,1): 0 | A(1,1,0,0,1): 8 |
| A(0,0,0,1,0): 0 | A(0,1,0,1,0): 0 | A(1,0,0,1,0): 0 | A(1,1,0,1,0): 9 |
| A(0,0,0,1,1): 0 | A(0,1,0,1,1): 2 | A(1,0,0,1,1): 5 | A(1,1,0,1,1): 0 |
| A(0,0,1,0,0): 0 | A(0,1,1,0,0): 0 | A(1,0,1,0,0): 0 | A(1,1,1,0,0):10 |
| A(0,0,1,0,1): 0 | A(0,1,1,0,1): 3 | A(1,0,1,0,1): 6 | A(1,1,1,0,1): 0 |
| A(0,0,1,1,0): 0 | A(0,1,1,1,0): 4 | A(1,0,1,1,0): 7 | A(1,1,1,1,0): 0 |
| A(0,0,1,1,1): 1 | A(0,1,1,1,1): 0 | A(1,0,1,1,1): 0 | A(1,1,1,1,1): 0 |

One can see that the elements in array “A” are non-zero whenever there are exactly three index values equal to “1” and in all other cases the elements in array “A” are zero. Furthermore, one can see that there are exactly ten different elements in array “A” that have exactly 3 index values equal to “1” and that these ten different elements contain the values 1, 2,. . . , 10, respectively. The array “A” is easily initialized via a nested “For Loop” in which an incrementing counter, whose initial value is one, is assigned to the array element if the sum of the index values is three, and is assigned zero otherwise. Array “A” can be used to compute PAV index values as follows: Suppose that we have a first subset of three Q&As consisting of Q&A₂, Q&A₃, and Q&A₅. In that case, n₁=0, n₂=1, n₃=1, n₄=0, and n₅=1, and array element A(0,1,1,0 1)=3. Therefore, index₁=3. If we have a second subset of three Q&As consisting of Q&A₂, Q&A4, and Q&A₅, then n₁=0, n₂=1, n₃=0, n₄=1, n₅=1, A(0,1,0,1,1)=2, and so index₂=2. If there are k different subsets, and hence k different index values, then each index value is computed in a similar manner. If instead of using values n=5 and m=3, we were to use values n=9 and m=5, then “A” would be a nine-dimensional array with nine index values of 0 or 1, and the array would be initialized with t=9C5=9!/(5!4!)=126 different index values 1, 2, . . . , 126.

The PE client sends ID, and (index₁, PAV_{index}_{₁}), (index₂, PAV_{index}_{₂}), . . . , (indexₖ, PAV_{index}_{ₖ}) to the PE-authentication server computer and requests the PE-authentication server computer to authenticate the PE user in function block 1408. The PE-authentication server computer 23 (FIG. 2) uses the received ID, to retrieve the personal authentication values PAV_{l,1}, PAV_{l,2}, . . . , PAV_{l,1}, stored in row “i” of its database in function block 1409.

Referring now to FIG. 14B, in function block 1410, the PE-authentication server computer searches for a value “j” such that PAV_{J} for some value (j, PAV_{J}) in the list (index₁, PAV_{index}_{₁}), (index₂, PAV_{index}_{₂}), . . . , (indexₖ, PAV_{index}_{ₖ}) received from the PE client applet is equal to the value PAV_{l,J} in the list PAV_{l,2}, . . . , PAV_{l,t} retrieved from the PE-authentication server computer database 24 (FIG. 2). A determination is made in decision block 1411 to determine if such a value is found. If so, then the PE user with identifier ID, is authenticated; otherwise, the PE user is not authenticated. If the PE user is authenticated, the PE-authentication server computer sends a “positive response” to the PE client applet in function block 1412. Along with the “positive response”, the PE-authentication server computer also sends: (1) the index value “j”, (2) the j-th encrypted PE secret value eK_{lJ}(PE_Secret) for PE user with identifier IDₗ retrieved from the PE-authentication server computer database, and (3) the encrypted PE answers ePE_Secret(A₁), ePE_Secret(A₂), . . . , ePE_Secret(Aₙ) for PE user with identifier IDₗ retrieved from the PE-authentication server computer database. If the PE user is not authenticated, the PE-authentication server computer sends a “negative response” to the PE client applet in function block 1415. If the PE user is successfully authenticated, then the PE client applet uses index value “j” received from the PE-authentication server computer to identify the j-th subset of questions and the j-th subset of answers used to compute PAV_{J} in function block 1413, and this information is saved in function block 1414 so that it will be available to the Recover PE function. The PE client applet then exits the PE answering algorithm and control passes to function block 1208 (FIG. 12A) of the Recover PE function. If the PE user is not successfully authenticated, a determination is made in decision block 1416 as to whether there are any unanswered questions. If the PE user is not successfully authenticated and there are no unanswered questions, a determination is made in decision block 1417 as to whether there are Q&As yet to be processed. If the PE user is not successfully authenticated and there are no unanswered questions (n−m−k₁0) and there are sufficient Q&As available for further processing (k₁+k₂≧3), then control passes to step 1432 of the PE answering algorithm. If the PE user is not successfully authenticated and there are no unanswered questions (n−m−k₁=0) and there are insufficient Q&As available for further processing (k₁+k₂<3), then the PE client applet exits the PE answering algorithm at function block 1418 and control passes to function block 1212 (FIG. 12B) of the Recover PE function. If the PE user is not successfully authenticated and there are unanswered questions (n−m−k₁>0), then control passes to function block 1419 where the user is prompted to select a third set of questions and provide answers. The PE user's answers are received in function block 1420.

One method for determining the j-th subsets of questions and answers using index “j” would be to search the elements of array “A” until an element is found equal to “j”. The index values {I₁, I₂, . . . , Iₙ} of array “A” would then determine the j-th subsets of questions and answers. For example, if n=9, m=5 and I₁=1, I₂=0, I₃=0, I₄=1, I₁=1, I₆=0, I₇=1, I₈=1, I₉=0, and user authentication is based on say, five, Q&As, then the j-th subsets of questions and answers would consist of {Q₁, Q₄, Q₅, Q₇, Q₈} and {A₁, A₄, A₅, A₇, A₈}, respectively, where we assume that the “n” questions and answers can be arranged in a canonical order and the indices refer to the canonical positions of the respective elements. Note that the intent here is to only show that a method does exist to map the index value “j” back to the j-th subsets of questions and answers; the illustrated method is not a “best” method.

Referring back to FIG. 14B, the PE user selects a third set of “k₂” of the “n−m−k₁” additional unanswered questions (0<k₂≦n−m−k₁), where “k₂” is a variable value determined by the PE user in function block 1419. The PE user then provides answers to the selected “k₂” questions in function block 1420. As before, the PE user can make use of the displayed system usage data, or portion thereof, or function thereof, to select the “k₂” additional questions. The value “k₂” can change from PE session to PE session and from PE user to PE user. In this case, the PE answering algorithm (via the UI) permits the PE user to select up to “n−m−k₁” additional questions and provide answers, but does not require the PE user to answer additional questions—answering additional questions is strictly optional.

The PE user clicks on a “submit” button displayed to the PE user by the UI on the display screen in function block 1419. This indicates to the PE client applet that the PE user is finished providing answers to selected questions. At any time prior to clicking on the “submit” button, the PE user is permitted to change answers to any of the previously selected “m+k₁+k₂” questions.

Referring now to FIG. 14C, in fuinction block 1421, the PE client applet computes the personal authentication values PAV_{index}_{₁}, . . . , PAV_{index}_{₂}, . . . , PAV_{index}_{ₖ} from the k=(m×k₂) combinations of“m” Q&As drawn from the set of “m+k₂” Q&As provided by the PE user. The PE client applet also computes the index values index₁, index₂, . . . , indexₖ in function block 1421. The j-th personal authentication value, PAV_{index}_{_{J}}, is computed, as described above, using the formula:

PAV_{index}_{_{J}}=F₁(j-th subset of“m” questions drawn from set {Q₁, Q₂, Qₘ₊ₖ_{₂}}, j-th subset of “m” answers drawn from set {A₁, A₂, . . . , Aₘ₊ₖ_{₂}}, Other Information)

The k=(m×k₂) combinations of “m” Q&As used to compute personal authentication values is determined as follows: Each combination of “m-1” Q&As drawn from the first set of “m” Q&As specified in function block 1402 (FIG. 14A (resulting in “m” combinations) is combined with each combination of one Q&A drawn from the third set of “k₂” Q&As specified in function block 1419 (FIG. 14B) (resulting in k₂ combinations). For example, if m=5 and k₂=2, then there are 5×2=10 ways to combine four Q&As drawn from the first set of five Q&As (five combinations) with one Q&A drawn from the second set of two Q&As (two combinations).

If the PE answering algorithm detects in decision block 1416 that there are no remaining unanswered questions (n−m−k₁=0), then the PE user is given no opportunity to select additional questions in function block 1419, in which case the third set of Q&A is empty, k₂=0, and the PE user never reaches the present step in fuinction block 1421 of FIG. 4C. Thus, if function block 1421 is reached, we are assured that the third set of Q&As is not empty and k₂>0.

The values of index (index₁, index₂, . . . , indexₖ) are computed using the n-dimensional array “A,” as follows:

index=A(I₁, I₂, . . . , Iₙ) where,

Iₚ=1, if the p-th Q&A is present

Iₚ=0, if the p-th Q&A is not present and the elements of array “A” range in value from 0 to t, where t=t₁+t₂, t₁=nCm=n!/m!(n-m)! and t₂=nC(m+1)=n!(m+1)!(n-m-1)!. For example, index₁ is computed using the first subset of “m” Q&As, index₂ is computed using the second subset of“m” Q&As, and so forth, and indexₖ is computed using the k-th subset of “m” Q&As. Array “A” is initialized as follows: (1) if I₁+I₂+ . . . +Iₙ=m, then A(I₁, I₂, . . . , Iₙ) is assigned a value from 1 to t₁, where each value from 1 to t₁ occurs only once in array “A”, (2) if I₁+I₂+ . . . +Iₙ=m+1, then A(I₁, I₂, . . . , Iₙ) is assigned a value from (t₁+1) to (t₁+t₂), where each value from (t₁+1) to (t₁+t₂) occurs only once in array “A,” and (3) if I₁+I₂+ . . . +Iₙ≠m and I₁+I₂+ . . . +I₁ₙ≠m+1, then A(I₁, I₂, . . . , Iₙ) is assigned value zero “0.” It is assumed that the “n” Q&As have a canonical order such that, given any one of the “n” Q&A, its rank or position within the ordered list of Q&As can be easily determined. For example, the Q&A could be ordered according to the sorted order of the questions, which are arranged in ascending sequence. The first Q&A is associated with index I₁, the second Q&A is associated with index I₂, and so forth. Hence, given any subset of“m” or “m+1” Q&As drawn from the set of“n” Q&As, one can easily compute its index by determining the rank or position of each Q&A in the canonical list of Q&As, determining the values of I_{1, I}₂, . . . , Iₙ, and then accessing element A(I_{1, I}₂, . . . , Iₙ) in matrix “A.”

In function block 1422, the PE client applet sends IDₗ and (index₁, PAV_{index}_{₁}), (index₂, PAV_{index}_{₂}), . . . , (indexₖ, PAV_{index}_{ₖ}) to the PE-authentication server computer 23 (FIG. 2) and requests the PE-authentication server computer to authenticate the PE user. The PE-authentication server computer uses the received IDₗ to retrieve the personal authentication values PAV_{l,1}, PAV_{l,2}, . . . , PAV_{l,t} stored in row “i” of its database 24 (FIG. 2) in function block 1423.

In function block 1424, the PE-authentication server computer searches for a value “j” such that the value PAV_{J} for some (j, PAVⱼ) in the list (index₁, PAV_{index}_{₁}), (index₂, PAV_{index}_{₂}), . . . , (indexₖ, PAV_{index}_{ₖ}) received from the PE client applet is equal to the value PAV_{l,J}, in the list PAV_{l,1}, PAVₗ₂, . . . , PAV_{l,t} retrieved from the PE-authentication server computer database. A determination is made in decision block 1425 as to whether such a value is found. If so, then the PE user with identifier IDₗ is authenticated; otherwise, the PE user is not authenticated. If the PE user is authenticated, the PE-authentication server computer sends a “positive response” to the PE client applet in function block 1426. Along with the “positive response” are sent the following: (1) index value “j”, (2) the j-th encrypted PE secret value eK_{lJ}(PE_Secret) for PE user IDi retrieved from the PE-authentication server computer database, and (3) the encrypted PE answers ePE_Secret(A_{t,1}), ePE_Secret(A_{t,2}), . . . , ePE_Secret(A_{t,n}) for PE user IDₗ retrieved from the PE-authentication server computer database. If the PE user is not authenticated, the PE-authentication server computer sends a “negative response” to the PE client applet in function block 1429. If the PE user is successfully authenticated, then the PE client applet uses index value “j” received from the PE-authentication server computer to identify the j-th subset of questions and the j-th subset of answers used to compute PAV_{J} in function block 1427, and this information is saved in function block 1428 so that it will be available to the Recover PE function. The PE client applet then exits the PE answering algorithm and control passes to function block 1208 (FIG. 12A) of the Recover PE function. If the PE user is not successfully authenticated, a determination is made in decision block 1430 to determine if there are sufficient Q&As available for further processing (k₁+k₂≧3). If so, then control passes to the next step in function block 1432 of FIG. 14D of the PE answering algorithm. If the PE user is not successfully authenticated and there are insufficient Q&As available for further processing (k₁+k₂<3), then the PE client applet exits the PE answering algorithm in function block 1431 and control passes to the step in function block 1212 (FIG. 12B) of the Recover PE function.

One method for determining the j-th subsets of questions and answers using index “j” would be to search the elements of array “A” until an element is found equal to “j”. The index values {I₁, I₂, . . . , Iₙ} of array “A” would then determine the j-th subsets of questions and answers. For example, if n=9,m=5 and I₁=1,I₂=0,I₃=0,I₄=1,I₅=1,I₆=0,I₇=1,I₈=1,I₉=0, and user authentication is based on five Q&As, then the j-th subsets of questions and answers would consist of {Q₁, Q₄, Q₅, Q₇, Q₈} and {A₁, A₄, A₅, A₇, A₈}, respectively, where we assume that the “n” questions and answers can be arranged in a canonical order and the indices refer to the canonical positions of the respective elements. Note that the intent here is to only show that a method does exist to map the index value “j” back to the j-th subsets of questions and answers; the illustrated method is not a “best” method.

Referring now to FIG. 14D, in function block 1432, the PE client applet computes the personal authentication values PAV_{index}_{₁}, PAV_{index}_{₂}, . . . , PAV_{index}_{ₖ} from the k=mC(m-2)+(k₁+k₂)C3=m!/(m-2)!2! +(k₁+k₂)!/3!(k₁+k₂-3)! combinations of“m+1” Q&As drawn from the set of “m +k₁+k₂” Q&As provided by the PE user. The PE client applet also computes the index values index₁, index₂, . . . , indexₖ in function block 1432 in FIG. 14D. The j-th personal authentication value, PAV_{index}_{_{J}}, is computed as follows:

PAV_{index}_{_{J}}=F₁(j-th subset of “m+1” questions drawn from set {Q₁, Q₂, . . . , Qₘ₊ₖ_{₁}ₖ_{₂}}, j-th subset of “m+1” answers drawn from set {A₁, A₂, . . . , Aₘ₊ₖ_{₁}ₖ_{₂}}, Other Information)

The K=mC(m-2)×(k₁+k₂)C3=m!/(m-2)!2!×(k₁+k₂)!/3!(k₁+k₂-3)! combinations of “m+1” Q&As used to compute personal authentication values is determined as follows: Each combination of “m-2” Q&As drawn from the first set of “m” Q&As specified in function block 1402 (FIG. 14A) (resulting in m!/(m-2)!2! combinations) is combined with each combination of three Q&As drawn from the union of the second and third sets of Q&As specified in function block 1403 (FIG. 14A) and function block 1419 (FIG. 14B), respectively (resulting in (k₁+k₂)!/3!(k₁+k₂-3)! combinations). If the PE user elected not to answer additional questions in function block 1403, then the second set of Q&A is empty and k_{1=0.} If the PE answer algorithm detects in decision block 1416 that there are no remaining unanswered questions (n−m−k₁₌₀), then the PE user is given no opportunity to select additional questions in function block 1419, in which case the third set of Q&A is empty and k₂=0.

The values of index (index₁, index₂, . . . , indexₖ) are computed using the n-dimensional array “A,” as follows:

index A(I₁, I₂, . . . , Iₙ) where,

Iₚ=1, if the p-th Q&A is present

Iₚ=0, if the p-th Q&A is not present and the elements of array “A” range in value from 0 to t, where t=t₁+t₂, t₁=nCm=n!/m!(n-m)! and t₂=nC(m+1)=n!/(m+1)!(n-m-1)!. For example, index₁ is computed using the first subset of“m+1” Q&As, index₂ is computed using the second subset of“m+1” Q&As, and so forth, and indexₖ is computed using the k-th subset of“m+1” Q&As. Array “A” is initialized as follows: (1) if I₁+I_{2+ . . .+I}ₙ=m, then A(I₁, I₂, . . . , Iₙ) is assigned a value from 1 to t₁, where each value from 1 to t₁ occurs only once in array “A”, (2) if I₁+I₂+. . . +Iₙ=m+1, then A(I₁, I₂, . . . , Iₙ) is assigned a value from (t₁30 1) to (t₁+t₂), where each value from (t₁+1) to (t₁+t₂) occurs only once in array “A,” and (3) if I₁+I₂+ . . . +Iₙ≠m and I₁+I₂+ . . . +Iₙ≠m+1, then A(I₁, I₂, . . . , Iₙ) is assigned value zero “0.” It is assumed that the “n” Q&As have a canonical order such that, given any one of the “n” Q&A, its rank or position within the ordered list of Q&As can be easily determined. For example, the Q&A could be ordered according to the sorted order of the questions, which are arranged in ascending sequence. The first Q&A is associated with index ₁, the second Q&A is associated with index I₂, and so forth. Hence, given any subset of“m” or “m+1” Q&As drawn from the set of“n” Q&As, one can easily compute its index by determining the rank or position of each Q&A in the canonical list of Q&As, determining the values of I₁, I₂, . . . , Iₙ,000 and then accessing element A(I₁, I₂, . . . , Iₙ) in matrix “A.”

In function block 1433, the PE client applet sends IDₗ and (index₁, PAV_{l,1},, ), (index₂, PAV_{index}_{₂}), . . . , (indexₖ, PAV_{index} _{ₖ}) to the PE-authentication server computer and requests the PE-authentication server computer to authenticate the PE user.

The PE-authentication server computer 23 (FIG. 2) uses the received IDₗ to retrieve the personal authentication values PAV_{l,1}, PAV_{l,2}, . . . , PAV_{l,t}, stored in row “i” of its database 24 in function block 1434. In function block 1435, the PE-authentication server computer searches for a value “j” such that the value (j, PAV_{J}) in the list (index₁ PAV_{index}₁), (index₂, PAV_{index}_{₂}), . . . , (indexₖ, PAV_{index}_{ₖ}) received from the PE client applet is equal to value PAV_{l,J}, in the list PAV_{l,1}, PAV_{l,2}, . . . , PAV_{l,t}, retrieved from the PE-authentication server computer database. A determination is made in decision block 1436 as to whether such a value is found. If so, then the PE user with identifier IDₗ is authenticated; otherwise, the PE user is not authenticated. If the PE user is authenticated, the PE-authentication server computer sends a “positive response”to the PE client applet in function block 1437. Along with the “positive response”are sent the following: (1) the index value “j”, (2) the j-th encrypted PE secret value eK_{lJ},(PE_Secret) for PE user with identifier IDₗ retrieved from the PE-authentication server computer database, and (3) the encrypted PE answers ePE_Secret(A_{t,1}), ePE_Secret(A_{t,2}), . . . , ePE_Secret(A_{t,n}) for PE user with identifier IDₗ retrieved from the PE-authentication server computer database. If the PE user is not authenticated, the PE-authentication server computer sends a “negative response” to the PE client applet in function block 1440. If the PE user is successfully authenticated, then the PE client applet uses index value “j” received from the PE-authentication server computer to identify the j-th subset of questions and the j-th subset of answers used to compute PAV_{J} in function block 1438, and this information is saved in function block 1439 so that it will be available to the Recover PE function. The PE client applet then exits the PE answering algorithm and control passes to function block 1208 (FIG. 12A) of the Recover PE function. If the PE user is not successfully authenticated, then the PE client applet exits the PE answering algorithm and control passes to function block 1212 (FIG. 12B) of the Recover PE function.

One method for determining the j-th subsets of questions and answers using index “j” would be to search the elements of array “A” until an element is found equal to “j”. The index values {I₁, I₂, . . . , Iₙ} of array “A” would then determine the j-th subsets of questions and answers. For example, if n=9, m=5 and I₁=1, I₂=0, I₃=0, I₄=1, I₅=1, I₆=0, I₇=1, I₈=1, I₉=1, and user authentication is based on, say, 6 Q&As, then the j-th subsets of questions and answers would consist of {Q₁, Q₄, Q₅, Q7, Q₈, Q₉} and {A₁, A₄, A₅, A₇, A₈, A₉}, respectively, where we assume that the “n” questions and answers can be arranged in a canonical order and the indices refer to the canonical positions of the respective elements. Note that the intent here is to only show that a method does exist to map the index value “j” back to the jth subsets of questions and answers; the illustrated method is not a “best” method.

In a first variation of the second embodiment of the PE answering algorithm, the PE user is allowed to answer only “m” questions at the first iteration of the PE answering algorithm. That is, the variable k₁ is forced to be zero “0.” In this case, the user selects and answers “m” questions at the first iteration of the PE answering algorithm and selects and answers from 1 to “n-m” questions at the second iteration of the PE answering algorithm.

In a second variation of the second embodiment of the PE answering algorithm, the PE user is allowed to repeat the final step of selecting and answering k₂ questions until one of the following conditions is met: (1) the PE user is successfully authenticated, (2) the PE user chooses to discontinue, or (3) the PE user fails to be authenticated after answering all n questions.

In a third variation of the second embodiment of the PE answering algorithm, the system can make k₁ or k₂ or both predetermined constants, in which case they would be fixed values rather than variable values determined by each PE user.

In a preferred implementation of the second embodiment of the PE answering algorithm, n=9, m=5, and k₁=0 are predeternined constants determined by the PE answering algorithm and k₂=1, 2, 3, or 4 is a variable value determined by the PE user, which can change from PE session to PE session and PE user to PE user. At the first iteration, the PE user must select and answer five of the nine questions. The PE system attempts to authenticate the PE user on the basis of the specified five Q&As. If unsuccessful, then a second iteration is performed in which the PE user must select and answer from one to four of the remaining four unanswered PE questions. The PE system again attempts to authenticate the PE user, except in this case only (5×k₂) of the total (5+k₂)C5=(5+k₂)!/5!k₂! combinations of five Q&As are selected and used for authentication. For example, if k₂=1, then (5×1)=5 and (5+1)C5=6; if k₂=2, then (5×2)=10 and (5+2)C5=21; if k₂=3, then (5×3)=15 and (5+3)C5=56; if k₂=4, then (5×4)=20 and (5+4)C5=126. In particular, the subsets of five Q&As used to authenticate the PE user are obtained by combining each possible combination of four Q&As selected from the five Q&As specified at the first iteration with each possible combination of one Q&A selected from the k₂=1, 2, 3, or 4 Q&As specified at the second iteration. If the PE user fails to be authenticated at the second iteration and there are sufficient Q&As available for further processing (k₂≧3), then the PE answering algorithm will further attempt to authenticate the user on the basis of six Q&As, where these six Q&As are selected in a predetermined way by the PE answering algorithm, from among the Q&As specified by the PE user. In particular, there are up to 5C3×k2C3=5!/3!2!×k_{2!/3} !(k₂-3)! different possible combinations of six Q&As that are, or can be, used to authenticate the PE user. They are: Each combination of three Q&As drawn from the initial set of five Q&As specified at the first iteration is combined with each combination of three Q&As drawn from the set of “k₂” Q&As specified at the second iteration.

The rationale for the (above) user authentication procedure associated with the preferred implementation of the second embodiment of the PE answering algorithm is basically the same as the rationale for the user authentication procedure associated with the preferred implementation of the first embodiment of the PE answer algorithm, except that the procedure attempts to take advantage of the additional k₂ answers without exposing the system to increased risks from “guessing attacks”. The threat of“guessing attacks” is countered by authenticating the user on the basis of six answers instead of five answers. In effect, this strategy limits the attacker's ability to accumulate guesses using combinations of only five answers, and instead forces the attacker to spread the “guessing” attempts or trials over combinations of both five and six answers. The procedure is based on the idea that the more questions the user answers the more correct answers there are likely to be. On one hand, the additional answers permit additional combinations of answers to be tested, thus increasing the probability that the user will be successfully authenticated. On the other hand, increasing the number of authentication trials also increases the risk of a “guessing attack,” except that in the present case the authentication trials using combinations of six answers instead of five answers.

Another important aim of the PE answer algorithm is that it should be capable of detecting “guessing attacks”. A guessing attack is an attack in which the attacker masquerades as another user and attempts to be authenticated as that user by correctly guessing the answers to at least “m” of the user's Q&As, if one implements the first embodiment of the PE answering algorithm or at least “m” or “m+1” of the user's Q&As, if one implements the second embodiment of the PE answering algorithm. It may be possible for the system to detect a “guessing attack” by observing an unusually high number of incorrect answers. The system could log the event under a heading of “possible guessing attack.” In that case, the system would keep track of each such observations, and the accumulation of data could be used by the system as a basis for requesting that the affected user change his/her PE Q&As or portion thereof (e.g., only the affected Q&As).

In the first and second embodiments of the PE answering algorithm, the greater the number of questions the PE user elects to answer, the more information there is available to the PE system to detect a “guessing attack.” For example, suppose that n=9, m=5, k₁=0 and k₂=4. In this case, the PE user provides an initial set of five answers and then later provides an additional four answers. If the PE user fails to authenticate under the first embodiment of the PE answering algorithm, the PE system knows that (1) the initial five Q&As contain at least two incorrect answers or (2) the initial five Q&As contain one incorrect answer and the four additional Q&As have four incorrect answers. Either of these situations seems unlikely. The PE user is not apt to incorrectly answer two or more of the questions in the initial five Q&As and likewise the PE user is not apt to incorrectly answer all four questions in the subsequent four Q&As. Hence, if the user fails to authenticate, the PE system may assume that the observed event is due to a possible attacker performing a guessing attack. Of course, genuine PE users will sometimes make mistakes, which accounts for calling the observed event a “possible” guessing attack. If the user fails to authenticate under the second embodiment of the PE answering algorithm, the PE system has even more information to conclude that the observed event is due to a possible “guessing attack.” In this case, the PE system knows that (1) the initial five Q&As contain at least two incorrect answers, or (2) the initial five Q&As contain one incorrect answer and the four additional Q&As contain four incorrect answers, or (3) the initial four Q&As contain at least three incorrect answers, or (4) the initial four Q&As contain two incorrect answers and the four additional Q&As contain at least two incorrect answers. Hence, if the user fails to authenticate, the PE system may assume that the observed event is due to a possible attacker performing a guessing attack. As stated before, genuine PE users may still sometimes make mistakes, which accounts for still calling the observed event a “possible” guessing attack.

Another important aim of the PE answering algorithm is that it should not require an inordinate amount of computational and storage resources and transmission times. The reader will appreciate that the first and second embodiments of the PE answering algorithm, and the associated PE Create and PE Recover functions in the present invention do not require inordinate computational and storage resources and transmission times. For example, in the preferred implementation of the first embodiment of the PE answering algorithm, the PE client applet computes and transmits to the PE-authentication server computer as few as one PAV and possibly as many as twenty-one PAVs. The PE-authentication server computer stores 126 PAVs and 126 encrypted copies of the PE_Secret.

In the preferred implementation of the second embodiment of the PE answering algorithm, the PE client applet computes and transmits to the PE-authentication server computer as few as one PAV and possibly as many as sixty-one PAVs. Of the sixty-one PAVs, twenty-one are computed from combinations of five Q&As and forty are computed from combinations of six Q&As. The PE-authentication server computer stores 210 PAVs, consisting of 126 PAVs computed from combinations of five Q&As and 84 PAVs computed from combinations of six Q&As. The PE-authentication server computer also stores 210 encrypted copies of the PE_Secret.

The reader will also note from a study of the present invention that the user's ability to create PE answers of high entropy is essentially unaffected by the solution methods described in the first and second embodiments of the PE answering algorithm, and in the described Create PE and Recover PE functions

Third Embodiment

The third embodiment of the PE answering algorithm is one that is adaptive, and may change from one PE session to the next. The third embodiment of the PE answering algorithm provides added protection against “guessing attacks.” In the third embodiment, the number of questions that the PE user must correctly answer is a function of the usage data collected in the Recover PE function by the PE system. When the PE user invokes the Recover PE function, the PE-authentication server computer examines the PE user's usage data stored in the PE-authentication server computer database to determine, out of the last “j” invocations of the Recover PE function, the instances when the user succeeded and failed to be authenticated. The information is used by the PE-authentication server computer to establish a number k₃ of PE questions that the PE user must correctly answer in order to be authenticated (k₃<n). The value of k₃ can vary from one PE session to the next. For example, if the PE-authentication server computer determines that the PE user was successfully authenticated on the last invocation of the Recover PE function, then the PE-authentication server computer might impose a “relaxed” criterion on PE user authentication. That is, the value of k₃ could be the minimum value m. Whereas, if the PE user fails to authenticate in some number of specified invocations of the Recover PE function since the last successful authentication, then the PE-authentication server computer would impose a more “stringent” criterion on PE user authentication. In that case, k₃ would be a value greater than “m.”

In the third embodiment, the PE-authentication server computer keeps a record of the outcomes (“success” or “failure”) of the last five invocations of the Recover PE function, O₁, O₂, . . . , O₅, for each PE user, where O₁ represents the last invocation, O₂ the next to last invocation, and so forth, “S” denotes success, and “F” denotes failure. If the PE user fails to be authenticated on no more than one successive invocation of the Recover PE function, i.e., (a) O₁=“S” or (b) O₁=“F” and O₂=“S”), then the PE-authentication server computer requires the PE user to correctly answer only “m” of the “n” questions, where we assume m+3≦n. This represents the minimum number of questions that the PE user can correctly answer to be authenticated. In effect, the PE-authentication server computer allows the PE user to interleave one “failure to authenticate” between each “success to authenticate” without being penalized. However, if the PE user fails to authenticate in two or three successive invocations of the Recover PE function, but no more, i.e., (a) O₁=“F”, O₂=“F”, and O₃=“S” or (b) O₁=“F”, O₂=“F”, O₃=“F”, and O₄=“S”, then the PE-authentication server computer requires the PE user to correctly answer “m+1” questions. If the PE user fails to authenticate in four or more successive invocations of the Recover PE function (0₁=“F”, O₂=“F”, O₃=“F” and O₄=“F”), then the PE-authentication server computer requires the PE user to correctly answer m+2 questions.

In a preferred implementation of the third embodiment, n=9 and m=5. In that case, the PE user must correctly answer five questions to be authenticated when O₁=“S” or O_{1,O}₂=“FS” or six questions when O₁,O₂,O₃=“FFS” or O₁,O₂,O₃,O₄=“FFFS” or seven questions when O₁,O₂,O₃,O₄=“FFFF”. The PE answering algorithm is designed as follows: For the case where five questions must be answered (i.e., O₁=“S” or O₁,O₂=“FS”), the PE answering algorithm can be based on the first or second embodiments of the present invention. In this case, the steps performed by the PE answering algorithm are different only if the PE user fails to authenticate after two successive invocations of the Recover PE function.

For the case where six questions must be answered (i.e., O₁,O₂,O₃=“FFS” or O₁,O₂,O₃,O₄=“FFFS”), the PE answering algorithm requires the PE user to answer all 9 of the PE questions, and the PE user is authenticated on the basis of finding a combination of 6 correct answers. Altogether there are 9C6=84 possible combinations of answers.

For the case where seven questions must be answered (i.e., O₁,O₂,O₃,O₄=“FFFF”), the PE answering algorithm requires the PE user to answer nine of the PE questions, and the PE user is authenticated on the basis of finding a combination of seven correct answers. Altogether there are 9C7=36 possible combinations of answers.

In a variation of the third embodiment, an even greater “grace period” is extended to the PE user before requiring six questions to be answered. In this case, up to two successive failures to authenticate can occur between successes to authenticate (i.e., O₁=“S” or O₁,O₂=“FS” or O₁,O₂,O₃=“FFS”). Six questions would need to be correctly answered when O₁,O₂,O₃,O₄=“FFFS” or O₁,O₂,O₃,O₄,O₅=“FFFFS.” Seven questions would need to be correctly answered when O₁,O₂,O₃,O₄,O₅=“FFFFF”.

One can see from a description of the third embodiment that it provides added protection against “guessing attacks”. An attacker who repeatedly initiates PE sessions and performs a “guessing attack” by invoking the Recover PE function will (in all probability) produce a string of repeated failures to authenticate before ever succeeding in finding a correct combination of answers. In that case, the PE-authentication server computer will repeatedly detect O₁,O₂,O₃,O₄,O₅=“FFFFF”. Hence, the attacker will be forced into attacking seven Q&A instead of five Q&A, i.e., the attacker will have to find a combination of seven correct answers rather that a combination of five correct answers, which is much more difficult. Of course, if the attacker interleaves the attack between instances in which the actual PE user authenticates himself or herself, then the attacker will be able to accumulate some guesses against combinations of five answers and six answers, although is soon forced to carry out the attack against combinations of seven answers, unless the attack is delayed until the actual PE user again initiates a PE session and is authenticated to the PE system. However, PE users may only initiate PE sessions infrequently, and in any case, much less frequently than the attacker is likely to make beneficial use of Interleaving the attacker, in this way, does not seem to be a particularly productive or useful approach. In this case, the attacker cannot repeatedly initiate PE sessions, one after the other, against the same PE user, but instead is forced to wait for the actual PE user to repeatedly initiate PE sessions and be authenticated, in which case the attack is not completely under the control of the attacker. On the other hand, if the PE user is not under attack from a “guessing attack”, then the PE answering algorithm provides plenty of latitude to the PE user to succeed in being authenticated, i.e., the PE user can continue to be authenticated by correctly answering five questions, and will only be required to correctly answer six or seven questions if he or she fails to authenticate after a reasonable number of attempts. One can see that if the PE user experiences difficulty in being authenticated, the PE system does not “lock up” and prevent the PE user from further attempting to be authenticated. Instead, it requires the PE user to correctly answer a greater number of PE questions. And, as soon as the PE user succeeds in being authenticated, the PE system resets itself and the PE user then only has to correctly answer five questions to be authenticated.

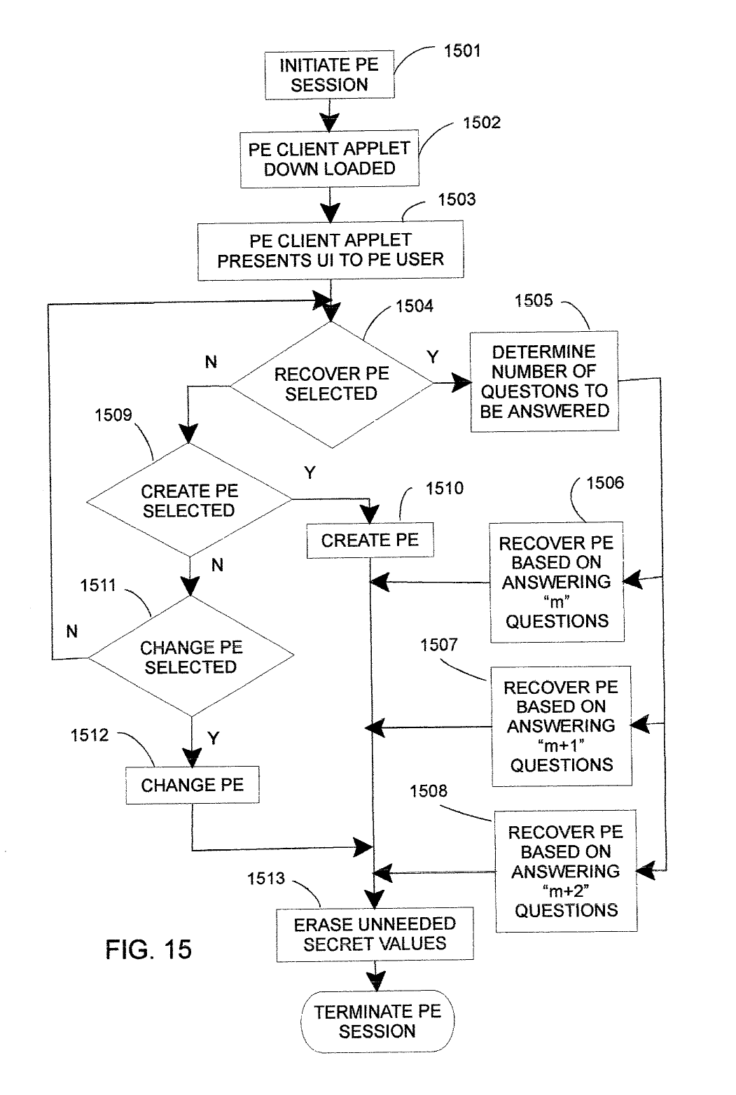

FIG. 15 is a flowchart of the steps in a typical PE session, in which the Recover PE function has a PE answering algorithm based on correctly answering “m” or “m+1” or “m+2” PE answers determined by the PE system. A PE user stationed at a PE-user client computer 25 (FIG. 2) equipped with a keyboard, mouse, monitor, and so forth, and with browser 90 (FIGS. 9A and 9B) open, initiates a PE session in function block 1501 by clicking on a hyper-link (URL) for the PE-controller server computer. In turn, the PE-controller server computer 21 (FIG. 2) causes the PE client applet, stored in the database of PE-controller server computer, to be downloaded and installed on the PE-user client computer 25 in function block 1502. The PE client applet is automatically given control (i.e., executed). The PE client applet displays the User Interface (UI) (for example, various HTML pages, or dynamically generated forms and graphics) to the user in function block 1503. The PE user then selects and performs one of the available PE functions (Create PE, Recover PE, or Change PE). This selection is detected by one of the decision blocks 1504, 1509 or 1511. If the Recover PE function is selected as determined in decision block 1504, the number of questions to be answered is determined in function block 1505. Depending on the determined number of questions to be answered, the Recover PE function is executed in function block 1506 based on “m” questions, in function block 1507 based on “m+1” questions, or in function block 1508 based on “m+2” questions. The determination is made both by the PE-authentication server computer, in order that PE-authentication server computer can enforce that user authentication is based on “m” or “m+1” or “m+2” answers, as the case may be, and by the PE answer algorithm, in order that the PE answering algorithm computes the appropriate PE values required by the PE-authentication server computer. If “m” is determined, then the Recover PE function, with PE answering algorithm based on answering “m” questions, is executed in function block 1506. APE answering algorithm based on answering “m” questions is described in the first and second embodiments of the present invention. If “m+1” is determined, then the Recover PE function, with PE answering algorithm based on answering “m+1” questions, is executed in function block 1507. In this case, the user answers all “n” PE questions and the user is authenticated if there are at least “m+1” correct answers. If “m+2” is determined, then the Recover PE function, with PE answering algorithm based on answering “m+2” questions is executed in function block 1508. In this case, the user answers all “n” PE questions and the user is authenticated if there at least “m+2” correct answers. If the Create PE function is selected as determined in decision block 1509, the PE client applet executes the steps of the Create PE function block 1510. If the Change PE function is selected as determined in decision block 1511, the Change PE function is executed in function block 1512. After the selected PE function has been executed, any remaining unneeded secret values are overwritten and then erased (overwriting is required because JVMs (Java Virtual Machines) use a “garbage collection” strategy which may leave sensitive values exposed for extended periods after they are nominally “deleted”) in function block 1513. Note that this “cleanup” step should also be carried out in each of the respective PE functions. When finished, the user terminates the PE session, e.g., by clicking on an “end” button displayed on the monitor's screen.

With either of the described embodiments (first, second or third), once the PE user has been authenticated, the PE system can provide additional information to the PE user enabling the PE user to tell which of his or her entered PE answers are correct or incorrect. For example, the PE system might display the correct answers. Or, the PE system might display the incorrect answers, in which case the PE user would visually see the incorrect answers and by inference could tell which PE answers had been entered correctly. The reader will appreciate that there are different ways in which this information could be displayed or conveyed to the PE user without departing from the spirit of the invention.

While the invention has been described in terms of preferred embodiments, those skilled in the art will recognize that the invention can be practiced with modification within the spirit and scope of the appended claims.

Having thus described my invention, what I claim as new and desire to secure by Letters Patent is as follows:

1. A method enabling a user of a computing system to generate a secret value from answers to questions previously created by the user, said method comprising the steps of:
displaying the questions previously created by the user;
prompting the user to select a first portion of the displayed questions and provide a first set of answers to the selected first portion of questions;
attempting to generate said secret value from a portion of the first set of answers and possibly other information;
if said secret value cannot be generated from at least a portion of the first set of answers and possibly other information, prompting the user to select a second portion of the displayed questions and provide a second set of answers to the selected second portion of questions; and
attempting to generate said secret value from a portion of said first and second sets of answers and possibly other information.

2. The method of claim 1, wherein there are n questions previously created by the user, and the user is prompted to select as said first portion at least m questions to answer but, at the user's option, can select k questions to answer, where 0<m≦k≦n and the set of k questions consists of a first subset of m questions and an optional subset of k₁ questions (k₁=k−m).

3. The method of claim 2, wherein there are n questions previously created by the user, and the user is prompted to select as said second portion a third set k₂ of the n−m−k₁ additional unanswered questions, where 0<k₂≦n−m−k₁ and k₂ is a variable value determined by the PE user.

4. The method of claim 3, wherein the PE user is allowed to repeat the step of selecting as said second portion a third set k₂ of the unanswered questions until one of the following conditions is met: (1) the PE user is successfully authenticated, (2) the PE user chooses to discontinue, or (3) the PE user fails to be authenticated after answering all n questions.

5. The method of claim 3, wherein the at least one of the values k₁ and k₂ is a constant.

6. The method of claim 3, wherein n=9, m=5, and k₁=O.

7. The method of claim 6, wherein k₂ is a variable value of 1, 2, 3, or 4 selected by the PE user.

8. The method of claim 1, wherein there are n questions previously created by the user, and the user is prompted to select as said first portion m questions to answer, where 0<m<n, and the user is prompted to select as said second portion 1to n−m as said second portion.

9. The method of claim 1, wherein there are n questions previously created by the user, and the user is prompted to select as said first portion at least m questions to answer but, at the user's option, can select k questions to answer, where 0<m<k<n and the set of k questions consists of a first subset of m questions and an optional subset of k₁ questions (k₁=k−m), and wherein the PE user is authenticated of m questions and answers in a predetermined way from among the questions and answers specified by the PE user.

10. The method of claim 9, wherein the PE user is allowed to repeat the step of selecting as said second portion a third set k₂ of the unanswered questions until one of the following conditions is met: (1) the PE user is successfully authenticated, (2) the PE user chooses to discontinue, or (3) the PE user fails to be authenticated after answering all n questions.

11. The method of claim 10, wherein the PE user is allowed to repeat the step of selecting as said second portion a third set k₂ of the unanswered questions until one of the following conditions is met: (1) the PE user is successfully authenticated, (2) the PE user chooses to discontinue, or (3) the PE user fails to be authenticated after answering all n questions.

12. The method of claim 11, wherein the at least one of the values k₁ and k₂ is a constant.

13. The method of claim 11, wherein n=9, m=5, and k₁=0.

14. The method of claim 13, wherein k₂ is a variable value of 1, 2, 3, or 4 selected by the PE user.

15. The method of claim 1, wherein if the PE user fails to be authenticated in successive invocations the step of attempting to generate said secret value, the PE user is required to correctly answer a number of questions greater than M.

16. The method of claim 15, wherein if the PE user fails to be authenticated in two or three successive invocations of the step of attempting to generate said secret value, the PE user is required to correctly answer m+1 questions.

17. The method of claim 16, wherein if the PE user fails to be authenticated in four or more successive invocations of the step of attempting to generate said secret value, the PE user is required to correctly answer m+2 questions.

18. The method of claim 1, further comprising the steps of:
authenticating the user upon generating the secret value; and
displaying incorrect answers to the user who has been successfully authenticated.

19. A method enabling a user of a computing system to generate a secret value from answers to questions previously created by the user, said method comprising the steps of:
displaying the questions previously created by the user;
prompting the user to select a first portion of the displayed questions and provide a first set of answers to the selected first portion of questions;
attempting to generate said secret value from a portion of the first set of answers and possibly other information;
prompting the user to select a second portion of the displayed questions and provide a second set of answers to the selected second portion of questions;
attempting to generate said secret value from a portion of said first and second sets of answers and possibly other information;
prompting the user to select a third portion of the displayed questions and provide a third set of answers to the selected third portion of questions, if said secret value cannot be generated from at least a portion of the first and second sets of answers and possibly other information; and
attempting to generate said secret value from a portion of said first, second, and third sets of answers and possibly other information, if said secret value cannot be generated from at least a portion of the first set of answers and possibly other information.

20. A method enabling a user of a computing system to generate a secret value from answers to questions previously created by the user, said method comprising the steps of:
displaying the questions previously created by the user;
prompting the user to select at least a portion of the displayed questions and provide answers to the selected portion of questions;
attempting to generate said secret value from a first sub-portion of the provided answers and possibly other information; and
if said secret value cannot be generated from said first sub-portion of the provided answers and possibly other information, attempting to generate said secret value from a second sub-portion of the provided answers.

21. The method of claim 20, wherein the second sub-portion of the provided answers has a greater number of answers than the first sub-portion of the provided answers.

22. The method of claim 20, wherein the second sub-portion of the provided answers contains some of the answers of the first sub-portion.

23. The method of claim 20, wherein the second sub-portion of the provided answers contains all of the answers of the first sub-portion.

24. The method of claim 20, wherein the second sub-portion of the provided answers contains none of the answers of the first sub-portion.

25. A method enabling a user of a computing system to generate a secret value from answers to questions previously created by the user, said method comprising the steps of:
displaying the questions previously created by the user;
prompting the user to select a first portion of the displayed questions and provide a first set of answers to the selected first portion of questions;
prompting the user to select a second portion of the displayed questions and provide a second set of answers to the selected second portion of questions;
attempting to generate said secret value from a portion of the first set of answers and possibly other information; and
if said secret value cannot be generated from at least a portion of the first set of answers and possibly other information, attempting to generate said secret value from a portion of the first and second sets of answers and possibly other information.

26. The method of claim 25, wherein if said secret value cannot be generated from at least a portion of the first and second sets of answers and possibly other information, further comprising the step of prompting the user to select a third portion of the displayed questions and provide a third set of answers to the selected third portion of questions.

27. A computing system enabling a user to generate a secret value from-answers to questions previously created by the user, said computing system comprising:
a user client computer, a controller computer and an authentication server computer;
a network connecting said user computer, said controller computer and said authentication server computer;
said controller computer downloading a client applet to said user client computer to begin an authentication session;
said user client computer executing the client applet to display the questions previously created by the user and prompt the user to select a first portion of the displayed questions and provide a first set of answers to the selected first portion of questions;
said authentication server computer attempting to generate said secret value from a portion of the first set of answers and possibly other information;
said user client computer responding to said authentication server computer and prompting the user to select a second portion of the displayed questions and provide a second set of answers to the selected second portion of the questions if said secret value cannot be generated from at least a portion of the first set of answers and possibly other information; and
said authentication server computer attempting to generate said secret value from a portion of said first and second sets of answers and possibly other information.

28. The computing system of claim 27, further comprising a repository of downloadable client applets attached to the controller computer, the client applets being downloadable to the user client computer and used for both creating the secret value from answers supplied by the user when originally creating the questions and, later, generating the secret value from answers provided by the user to subsets of the previously created questions.

29. The computing system of claim 27, further comprising a central database maintained by the authentication server computer, said central database containing information created by users which can be subsequently accessed by the controller server computer on behalf of the user.
